(19) United States
(12) Patent Application Publication
(10) Pub. No.: US 2015/0036584 A1
(43) Pub. Date: Feb. 5, 2015

(54) RELAY SERVER, SERVICE PROVIDING DEVICE, AND ACCESS CONTROL METHOD

(71) Applicant: FUJITSU LIMITED, Kawasaki-shi (JP)

(72) Inventors: Kazumasa USHIKI, Kawasaki (JP); Tadanobu Tsunoda, Yokohama (JP); Nobutsugu Fujino, Yokohama (JP)

(73) Assignee: FUJITSU LIMITED, Kawasaki-shi (JP)

(21) Appl. No.: 14/317,519

(22) Filed: Jun. 27, 2014

(30) Foreign Application Priority Data
Aug. 1, 2013 (JP) 2013-160477

(51) Int. Cl. H04L 29/08

(52) U.S. Cl. CPC H04L 67/16; H04L 67/2809; H04L 67/2842
USPC 370/315

(57) ABSTRACT

A relay server which relays communication between terminals, the server includes, a processor; and a memory which stores a plurality of instructions, which when executed by the processor, cause the processor to execute, storing policy information that designates a service capable of being provided for each group which is participated by at least one of the terminals, processing, based on the policy information, response information included in a response from a second terminal which corresponds to a request from a first terminal and transmitting the response information processed by the processor to the first terminal by communication, wherein the processing of the response information includes processing the response information such that a service capable of being provided by the second terminal is limited to a service capable of being provided to a group in which the first terminal participates.

### CROSS-REFERENCE TO RELATED APPLICATIONS

This application is based upon and claims the benefit of priority of the prior Japanese Patent Application No. 2013-160477 filed on Aug. 1, 2013, the entire contents of which are incorporated herein by reference.

### FIELD

The embodiments discussed herein are related to a relay server, a service providing device, and an access control method that are used in a wireless system, for example.

### BACKGROUND

As one of access control methods used in a wireless system, Universal Plug and Play (UPnP) Device Architecture 1.1 (UPnP Forum, UPnP Device Architecture 1.1, Oct. 15, 2008) which is established by UPnP Forum has been suggested. UPnP is a registered trademark.

In the UPnP Forum, a cooperation method between a terminal (device) which provides a service and a terminal (control point) which uses the service is specified. Hereinafter, a configuration or method which is specified in the UPnP Forum may be referred to as “UPnP standard”. In addition, in order to simplify the description, the control point will be referred to as a “controller”.

In the UPnP standard, when the controller has access to a network, the controller issues a terminal retrieval request (M-SEARCH) in order to retrieve a terminal which is present within a subnet of the network. The terminal retrieval request may designate a desired retrieval condition. The terminal retrieval request transmitted from the controller is received by all devices that are present within the subnet. Then, the device satisfying the retrieval condition sends a response to the controller that has issued the terminal retrieval request. Based on this procedure, the controller may retrieve a device which is present within the subnet.

Subsequently, the controller requests definition information (device definition information and service definition information) from the retrieved device. A type of a service provided by the device, and the like are described in the device definition information. In addition, an action, an argument, a state variable, a data type, and the like which constitute the service are described in the service definition information. Accordingly, the controller acquires the definition information, and thus may recognize a service to be provided by a device which is present within a subnet. These pieces of definition information are referred to as description in the UPnP standard.

### SUMMARY

In accordance with an aspect of the embodiments, a relay server which relays communication between terminals, the server includes, a processor; and a memory which stores a plurality of instructions, which when executed by the processor, cause the processor to execute, storing policy information that designates a service capable of being provided for each group which is participated by at least one of the terminals, processing, based on the policy information, response information included in a response from a second terminal which corresponds to a request from a first terminal and transmitting the response information processed by the processor to the first terminal by communication, wherein the processing of the response information includes processing the response information such that a service capable of being provided by the second terminal is limited to a service capable of being provided to a group in which the first terminal participates.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an example of a network system according to a first embodiment;

FIG. 2 is a diagram illustrating functions of a relay apparatus, a controller terminal, and a device terminal;

FIG. 3 is a diagram illustrating an example of a group participation policy DB;

FIG. 4 is a diagram illustrating an example of a group DB;

FIG. 5 is a diagram illustrating an example of a terminal DB;

FIG. 6 is a diagram illustrating an example of an access policy DB;

FIG. 7 is a diagram illustrating an example of a terminal participation group DB;

FIG. 8 is a diagram illustrating an example of device definition information;

FIG. 9 is a diagram illustrating an example of service definition information;

FIG. 10 is a sequence diagram illustrating an example of a group participation procedure;

FIG. 11 is a sequence diagram illustrating an example of a service request procedure;

FIG. 12 is a diagram illustrating an example of device definition information after being processed by a relay apparatus;

FIG. 13 is a diagram illustrating an example of service definition information after being processed by a relay apparatus;

FIG. 14 is a flowchart illustrating the processing of a group processing unit;

FIG. 15 is a flowchart illustrating the processing of a communication unit of a relay apparatus;

FIG. 16 is a flowchart illustrating the processing of a group management unit;

FIG. 17 is a flowchart illustrating the processing of a multicast message processing unit;

FIGS. 18A and 18B are diagrams illustrating an example of a terminal retrieval request message;

FIG. 19 is a diagram illustrating an example of a response message to a terminal retrieval request;

FIG. 20 is a flowchart illustrating the processing of a definition request message processing unit;

FIG. 21 is a diagram illustrating an example of a definition request message;

FIG. 22 is a flowchart illustrating the processing of a message processing unit;

FIG. 23 is a diagram illustrating an example of a network system according to a second embodiment;

FIG. 24 is a diagram illustrating functions of a group management apparatus, a controller terminal, and a device terminal;

FIG. 25 is a diagram illustrating an example of a terminal DB used in the second embodiment;

FIG. 26 is a sequence diagram illustrating an example of a group participation procedure according to the second embodiment;

FIG. 27 is a sequence diagram illustrating an example of a service request procedure according to the second embodiment;

FIG. 28 is a flowchart illustrating the processing of a group processing unit according to the second embodiment;

FIG. 29 is a flowchart illustrating the processing of a group management unit according to the second embodiment;

FIG. 30 is a flowchart illustrating the processing of a communication unit of a terminal according to the second embodiment;

FIG. 31 is a flowchart illustrating the processing of a multicast control unit;

FIG. 32 is a flowchart illustrating the processing of a service access control unit;

FIG. 33 is a diagram illustrating an example of device definition information in the second embodiment;

FIG. 34 is a diagram illustrating an example of service definition information in another embodiment; and

FIG. 35 is a diagram illustrating a hardware configuration of an apparatus used in a network system of the embodiment.

### DESCRIPTION OF EMBODIMENTS

### First Embodiment

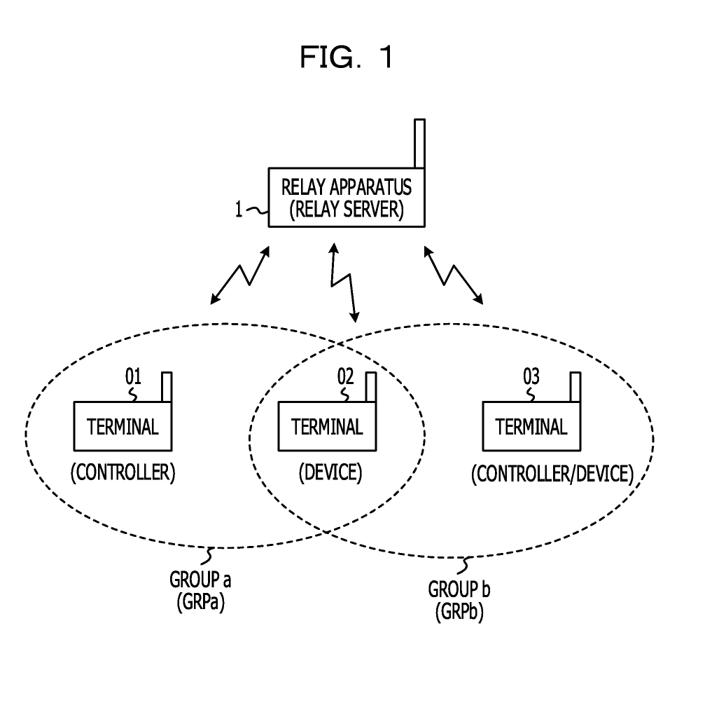

FIG. 1 illustrates an example of a network system according to a first embodiment. The network system includes a relay apparatus (relay server) 1. In addition, in this example, three terminals 01 to 03 are connected to the network system.

Each of the terminals 01 to 03 may communicate with another terminal through the relay apparatus 1. A wireless communication protocol between the relay apparatus 1 and the terminals 01 to 03 is not particularly limited. Meanwhile, it is assumed that each of the terminals 01 to 03 extracts data or information from a radio signal received from the relay apparatus 1 but does not extract data or information from a radio signal which is directly received from another terminal.

The terminal 01 operates as a controller that requests a service from a device. Accordingly, hereinafter, the terminal 01 is sometimes referred to as a “controller terminal”. The terminal 02 operates a device that provides the service requested from the controller. Accordingly, hereinafter, the terminal 02 is sometimes referred to as a “device terminal”. The terminal 03 is assumed to have functions of both the controller and the device.

Each of the terminals 01 to 03 may participate in a desired group. Here, each of the terminals 01 to 03 may participate in a plurality of groups. In the example illustrated in FIG. 1, the terminal 01 participates in a group “a”, the terminal 03 participates in a group “b”, and the terminal 02 participates in both the group “a” and the group “b”.

The relay apparatus 1 is provided on a path of communication between the controller and the device. Here, for example, when each terminal has a wireless LAN communication function, the relay apparatus 1 may be provided within a wireless LAN base station. In addition, the relay apparatus 1 holds group configuration information indicating in which group each of the terminals 01 to 03 participates. The relay apparatus 1 controls communication between the terminals 01 to 03, using the group configuration information.

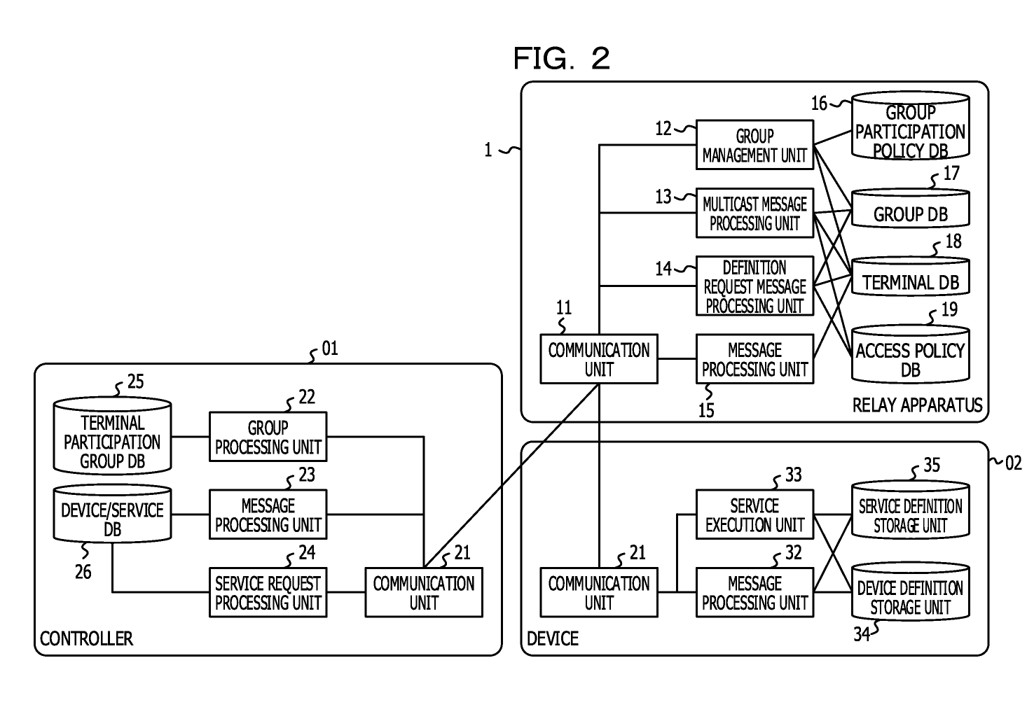

FIG. 2 is a diagram illustrating functions of the relay apparatus 1, the controller terminal 01, and the device terminal 02. Meanwhile, a wireless link between the relay apparatus 1 and the controller terminal 01 and a wireless link between the relay apparatus 1 and the device terminal 02 are set if desired.

The relay apparatus 1 includes a communication unit 11, a group management unit 12, a multicast message processing unit 13, a definition request message processing unit 14, a message processing unit 15, a group participation policy DB 16, a group DB 17, a terminal DB 18, and an access policy DB 19. Meanwhile, the relay apparatus 1 may have other functions.

The communication unit 11 provides a wireless interface with the terminal (controller, device). The communication unit 11 analyzes a message received from the terminal and forwards the received message to the group management unit 12, the multicast message processing unit 13, the definition request message processing unit 14, or the message processing unit 15. In addition, the communication unit 11 transmits a message generated by the group management unit 12, the multicast message processing unit 13, the definition request message processing unit 14, or the message processing unit 15 to a destination terminal.

The group participation policy DB 16 stores participation policy information. The participation policy information indicates in which group each terminal may participate. Meanwhile, the participation policy information is created by a network manager, for example.

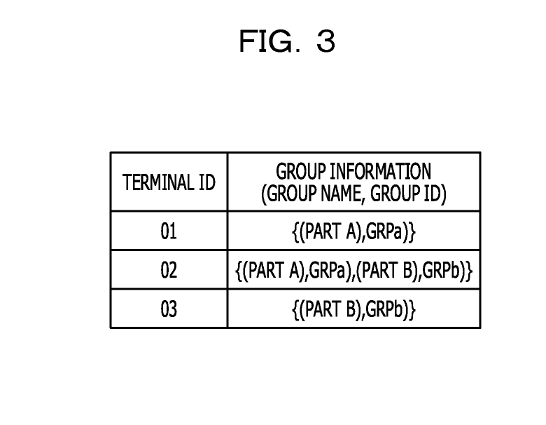

FIG. 3 illustrates an example of the group participation policy DB 16. The group participation policy DB 16 holds a correspondence relationship between a terminal ID for identifying each terminal and a group in which the terminal may participate. In this example, the terminal 01 is permitted to participate in the group “a” (group name: part A, group ID: GRPa). The terminal 02 is permitted to participate in both the group “a” and the group “b” (group name: part B, group ID: GRPb).

The group DB 17 stores group information. The group information indicates in which terminal each group participates. Meanwhile, the group DB 17 is updated when a group participation request or a group secession request is issued from the terminal.

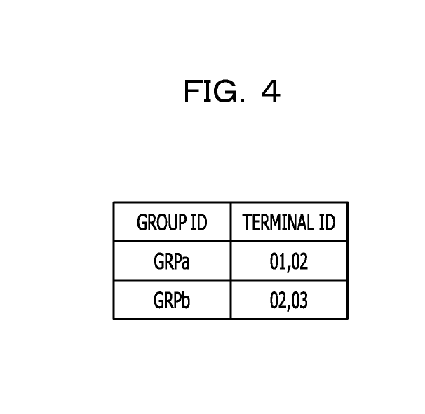

FIG. 4 illustrates an example of the group DB 17. The group DB 17 holds a correspondence relationship between a group ID for identifying each group and a terminal which participates in the group. In the example illustrated in FIG. 4, at present, the terminal 01 and the terminal 02 participate in the group “a”. In addition, at present, the terminal 02 and the terminal 03 participate in the group “b”. When a group participation request issued by a certain terminal is permitted, a terminal ID of the terminal is added to the group DB 17. In addition, when a group secession request is issued by a certain terminal, a terminal ID of the terminal is deleted from the group DB 17.

The terminal DB 18 stores information of each terminal used in the network system illustrated in FIG. 1. The terminal information registered with the terminal DB 18 is created by a network manager, for example.

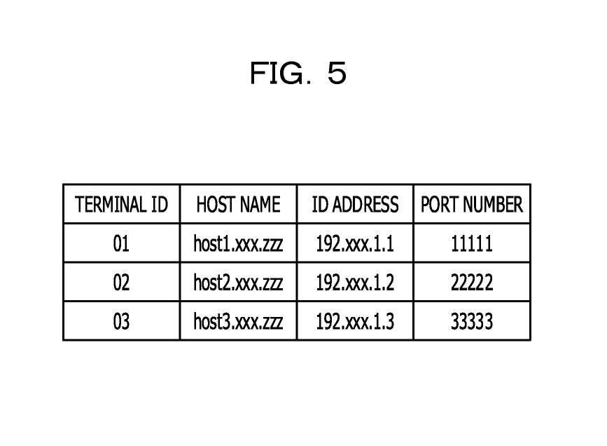

FIG. 5 illustrates an example of the terminal DB 18. In this example, the terminal DB 18 stores a host name, an IP address, and a port number with respect to a terminal ID. The host name is one of information for identifying a terminal, and is set in a Host field of an HTTP message transmitted to a corresponding terminal. The HTTP message includes a unicast terminal retrieval request message, a definition information request message, an action request message, and the like which are to be described later. The IP address is set in an IP header of a frame for transmitting a message. The port number is used at the time of transmitting the unicast terminal retrieval request message to be described later. The host name, the IP address, and the port number are allocated by a network manager, for example. The IP address may be dynamically given from a dynamic host configuration protocol (DHCP) server. In addition, when a terminal moves, the host name and/or the port number may be dynamically allocated by a system which is a movement destination of the terminal.

The access policy DB 19 stores access policy information. The access policy information indicates for which group a service provided by each device is permitted.

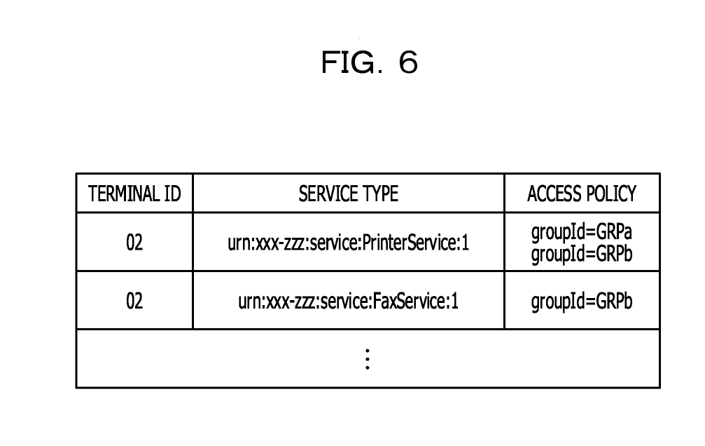

FIG. 6 illustrates an example of the access policy DB 19. In the example illustrated in FIG. 6, the terminal 02 provides a printer service and a facsimile service. Service type information identifies a service provided by a device terminal. In addition, an access policy indicates one or a plurality of groups that are permitted to provide a service. For example, the printer service is provided to a terminal which participates in the group “a” and/or the group “b”. The facsimile service is provided to only a terminal which participates in the group “b”. Meanwhile, the access policy DB 19 is updated when a group configuration of the network system changes. In addition, the access policy DB 19 is also updated when a service provided in the network system is added, changed, and deleted. The access policy DB 19 is updated by a network manager, for example.

The group management unit 12 retrieves a group in which a terminal may participate in response to a request from the terminal, and notifies the terminal of the retrieval result thereof. In addition, when the group management unit 12 receives a group participation request from a terminal, the group management unit 12 determines whether to permit to participate in a group which is designated in the request with reference to the group participation policy DB 16. When the group management unit 12 permits to participate in the designated group, the group management unit 12 registers a corresponding terminal ID with the group DB 17 in association with the designated group. In addition, when the group management unit 12 receives a group secession request from a terminal, the group management unit 12 deletes the corresponding terminal ID associated with the designated group from the group DB 17.

The multicast message processing unit 13 transmits a multicast terminal retrieval request transmitted from a controller terminal, to a terminal within a subnet. However, the multicast message processing unit 13 transmits the terminal retrieval request to only a terminal belonging to the same group as a transmission source terminal of the terminal retrieval request. At this time, the multicast message processing unit 13 converts the multicast terminal retrieval request into a unicast terminal retrieval request and transmits the converted multicast terminal retrieval request to each corresponding terminal. In addition, the multicast message processing unit 13 forwards a response to the terminal retrieval request to the transmission source terminal of the terminal retrieval request. At this time, the multicast message processing unit 13 may discard a response message including information which is not permitted to a group to which the transmission source terminal of the terminal retrieval request belongs.

Similarly to the multicast terminal retrieval request, the multicast message processing unit 13 may convert other multicast messages into unicast messages and may forward the converted messages to only the corresponding terminals. As other multicast messages, for example, a message (Advertisement) which advertises the presence of a device and a providing service, a message (byebye) which notifies the surroundings that a device secedes from a network, a message (update) which notifies the occurrence of a change in a connected network interface, and the like are assumed.

The definition request message processing unit 14 deletes a non-permitted description from a response message which is returned to a controller terminal from a device terminal. For example, when definition information is requested from the terminal 01 to the terminal 02, the terminal 02 returns the requested definition information. In this case, the definition request message processing unit 14 checks whether a description, which is not permitted to a group to which the terminal 01 belongs, is included in the definition information, with reference to the access policy DB 19. When the description, which is not permitted to the group to which the terminal 01 belongs, is included in the definition information, the definition request message processing unit 14 deletes the non-permitted description from the definition information. Thereafter, the relay apparatus 1 transmits the definition information from which the non-permitted description is deleted, to the terminal 01.

The message processing unit 15 processes other messages (that is, messages that are not processed by the group management unit 12, the multicast message processing unit 13, and the definition request message processing unit 14). For example, when the message processing unit 15 receives a service request message from a controller terminal, the message processing unit forwards the service request message to the corresponding device terminal. In addition, when the message processing unit 15 receives a response message from the device terminal, the message processing unit transmits the response message to the corresponding controller terminal.

As illustrated in FIG. 2, the controller terminal includes a communication unit 21, a group processing unit 22, a message processing unit 23, a service request processing unit 24, a terminal participation group DB 25, and a device/service DB 26. Meanwhile, the controller terminal may have other functions.

The communication unit 21 provides a wireless interface with the relay apparatus 1. The communication unit 21 analyzes a message received from the relay apparatus 1 and forwards the received message to the group processing unit 22, the message processing unit 23, or the service request processing unit 24. In addition, the communication unit 21 transmits a message generated by the group processing unit 22, the message processing unit 23, or the service request processing unit 24 to the relay apparatus 1.

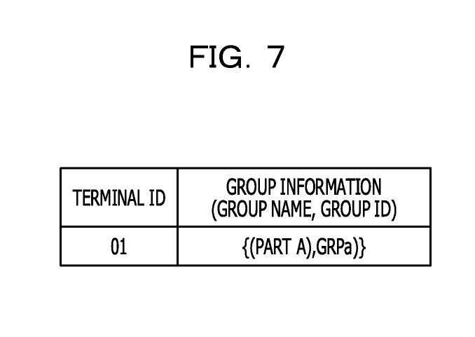

The terminal participation group DB 25 stores group information indicating a group in which a terminal participates. For example, FIG. 7 illustrates the terminal participation group DB 25 which is provided in the terminal 01. In this example, group information indicating that the terminal 01 participates in the group “a” is stored.

The device/service DB 26 stores information (for example, device definition information and service definition information) which is acquired from a device terminal which is present within a subnet. Meanwhile, a controller terminal acquires device definition information of a device terminal belonging to the same group as the controller terminal. In addition, the controller terminal acquires service definition information for a service permitted to the same group as the controller terminal.

The group processing unit 22 may request the participation in a desired group and the secession from any group, to the relay apparatus 1. When the participation in a designated group is permitted by the relay apparatus 1, the group processing unit 22 registers group information of the designated group with the terminal participation group DB 25. In addition, when the secession from the designated group succeeds, the group processing unit 22 deletes the group information of the designated group from the terminal participation group DB 25.

The message processing unit 23 creates a message including a request which is transmitted to a device terminal. In addition, the message processing unit 23 processes a message including a response which is received from the device terminal through the relay apparatus 1. Meanwhile, the message processing unit 23 stores the response (device definition information, service definition information, or the like) which is received from the device terminal in the device/service DB 26.

The service request processing unit 24 may request the execution of a service from the device terminal registered with the device/service DB 26. At this time, the service request processing unit 24 may request the execution of the service from the device terminal which is registered with the device/service DB 26.

As illustrated in FIG. 2, the device terminal includes a communication unit 31, a message processing unit 32, a service execution unit 33, a device definition storage unit 34, and a service definition storage unit 35. Although not illustrated in the drawing, similarly to the controller terminal, the device terminal includes the group processing unit 22 and the terminal participation group DB 25. Meanwhile, the device terminal may have other functions.

The communication unit 31 provides a wireless interface with the relay apparatus 1. The communication unit 31 analyzes a message received from the relay apparatus 1 and forwards the received message to the message processing unit 32 or the service execution unit 33. In addition, the communication unit 31 transmits a message generated by the message processing unit 32 or the service execution unit 33 to the relay apparatus 1.

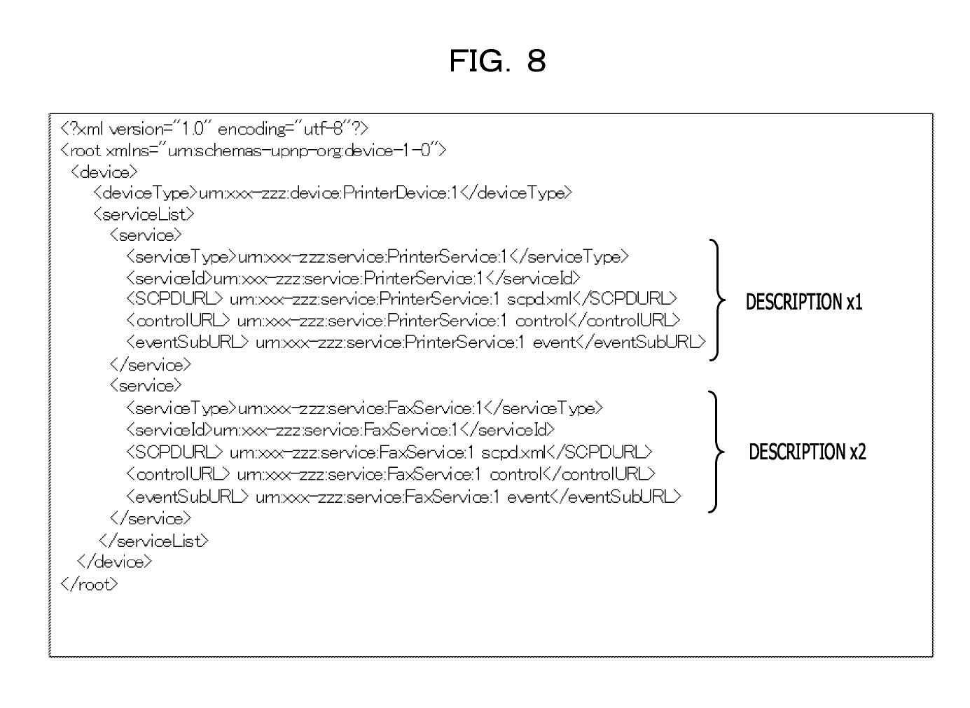

The device definition storage unit 34 stores device definition information. The device definition information includes a list of services that may be provided by the device terminal. For example, FIG. 8 illustrates the device definition information stored in the device definition storage unit 34 of the device terminal 02. In this example, the device terminal 02 may provide a printer service and a facsimile service. Meanwhile, a description x1 describes information on the printer service. In addition, a description x2 describes information on the facsimile service.

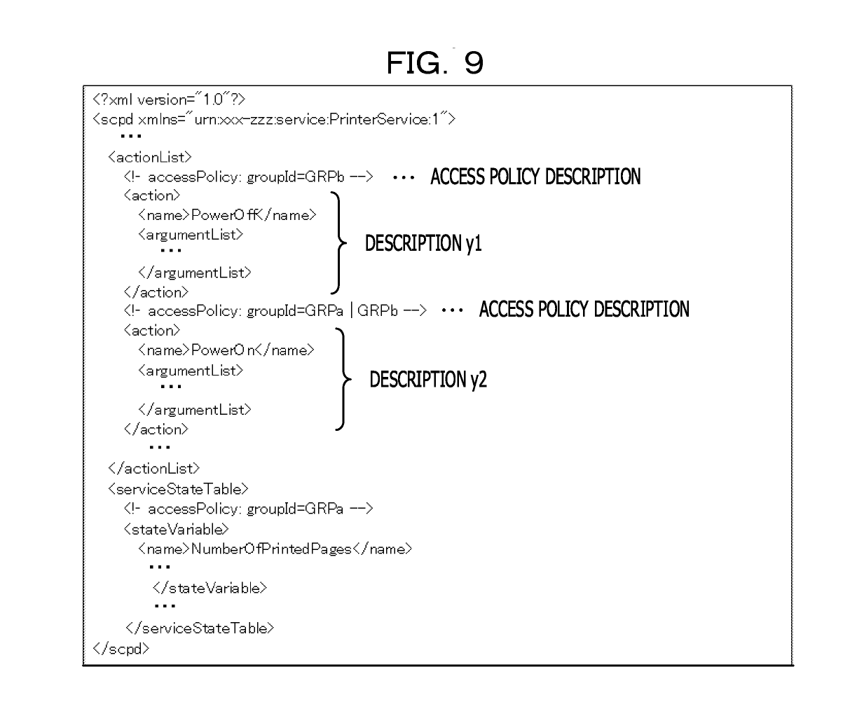

The service definition storage unit 35 stores service definition information. The service definition information includes detailed information (for example, an action, an argument, a state variable, a data type, and the like which constitute a service) on each service which is described in the device definition information. For example, FIG. 9 illustrates a portion of the service definition information stored in the service definition storage unit 35 of the device terminal 02. Specifically, FIG. 9 illustrates detailed information on a service (that is, printer service) which is described by the description x1 in the device definition information illustrated in FIG. 8. In this example, the service definition information of the printer service includes a description y1 and a description y2. The description y1 describes information on an action “Power Off” for turning off the power supply of a printer. The description y2 describes information on an action “Power On” for turning on the power supply of a printer. In addition, the service definition information includes an access policy description indicating a group for which each action is permitted. In this example, the “Power Off” is permitted to the group “b” by the access policy description, and the “Power On” is permitted to the group “a” and the group “b”. Meanwhile, the access policy description for each service illustrated in FIG. 9 may be provided to the relay apparatus 1 using a similar configuration to the access policy DB illustrated in FIG. 6, instead of being described in the service definition information.

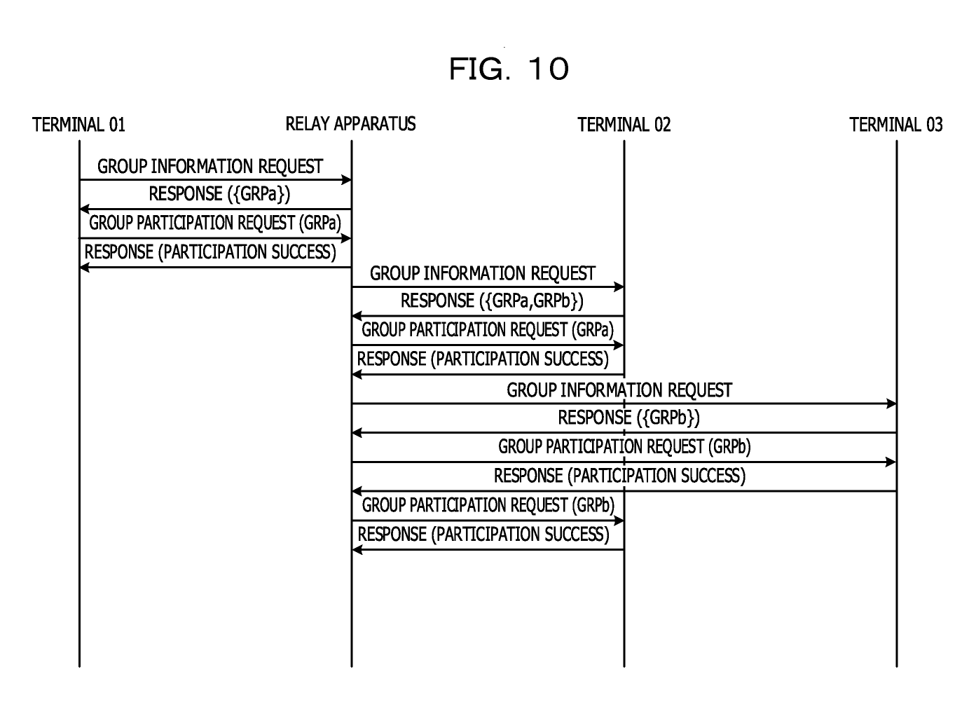

FIG. 10 illustrates an example of a group participation procedure. Herein, it is assumed that each of the terminals 01 to 03 illustrated in FIG. 1 participates in one or a plurality of groups. In addition, the relay apparatus 1 has the group participation policy DB 16 illustrated in FIG. 3.

The terminal 01 transmits a group information request message to the relay apparatus 1. When the relay apparatus 1 receives the group information request message from the terminal 01, the relay apparatus retrieves the group participation policy DB 16 and specifies a group in which the terminal 01 may participate. In this example, as illustrated in FIG. 3, the terminal 01 is permitted to participate in the group “a”. Accordingly, the relay apparatus 1 transmits a response message including a group ID (GRPa) for identifying the group “a” to the terminal 01. At this time, the relay apparatus 1 may transmit other pieces of information (for example, a group name and the like) to the terminal 01, in addition to the group ID.

The terminal 01 may request the participation in a permitted group. Therefore, the terminal 01 transmits a group participation request message for requesting the participation in the group “a”, to the relay apparatus 1. When the relay apparatus 1 receives the group participation request message from the terminal 01, the relay apparatus determines whether to accept the participation request with reference to the group participation policy DB 16. Then, the relay apparatus 1 notifies the terminal 01 of the determination result. In this example, the relay apparatus 1 transmits a response message indicating the success of the participation, to the terminal 01.

Thereafter, in the terminal 01, the group processing unit 22 records the participation of the terminal 01 in the group “a”, in the terminal participation group DB 25. In addition, in relay apparatus 1, the group management unit 22 records participation of the terminal 01 in the group “a”, in the group DB 17.

The terminal 02 and the terminal 03 also participate in the respective corresponding groups in a similar procedure. That is, the terminal 02 participates in the group “a” and the group “b”. At this time, the terminal 02 may request the participation in a plurality of groups (that is, groups “a” and “b”) using one group participation request message. In addition, the terminal 03 participates in the group “b”.

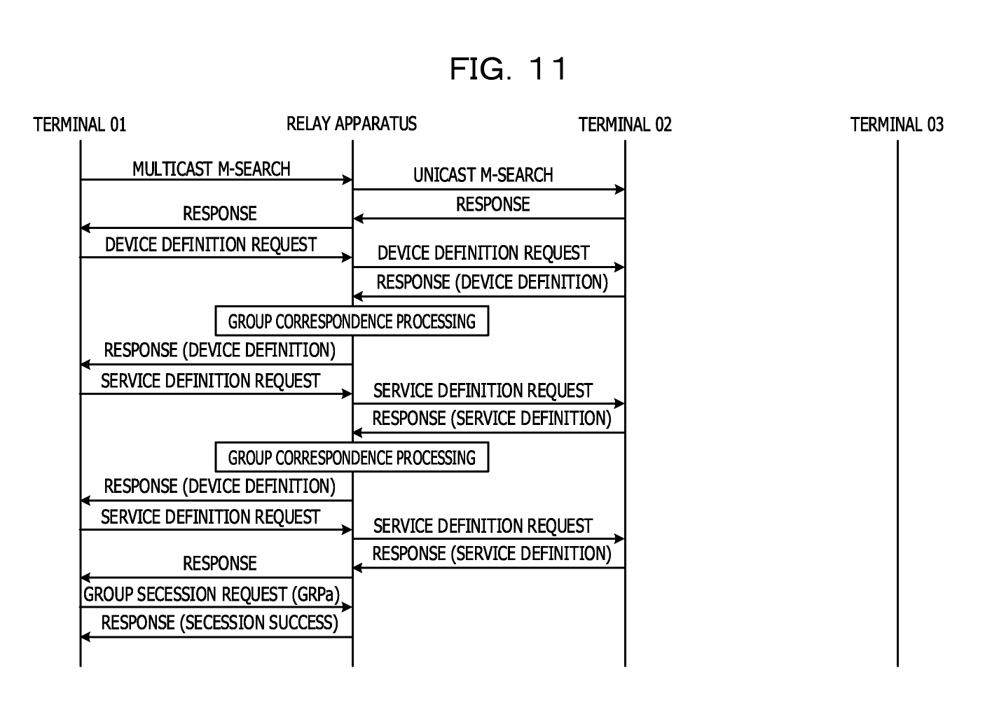

FIG. 11 illustrates an example of a service request procedure. In this example, it is assumed that the terminal 01 requests a service from the terminal 02. Meanwhile, the terminal 01 participates in the group “a” by the procedure illustrated in FIG. 10, but does not participate in the group “b”. In addition, the terminal 02 participates in the group “a” and the group “b”, and the terminal 03 participates in only the group “b”.

The terminal 01 transmits a terminal retrieval request (M-SEARCH) message to the relay apparatus 1 in order to retrieve which device terminal is present within a subnet. The message is a multicast message, and all terminals within the subnet are designated as destinations.

When the relay apparatus 1 receives the M-SEARCH message from the terminal 01, the relay apparatus specifies a group in which the terminal 01 participates, with reference to the group DB 17. In this example, the terminal 01 participates in the group “a”. Accordingly, the relay apparatus 1 transmits the M-SEARCH message to only a terminal that participates in the group “a”. At this time, the relay apparatus 1 converts the M-SEARCH message received from the terminal 01 from a multicast format to a unicast format. The relay apparatus 1 transmits the M-SEARCH message in the unicast format to terminals (except for a terminal which is a transmission source of the M-SEARCH message) which participates in the group “a”. In this example, the terminals 01 and 02 participate in the group “a”. Therefore, the relay apparatus 1 transmits the M-SEARCH message in the unicast format to the terminal 02. On the other hand, the terminal 03 does not participate in the group “a”. Accordingly, the relay apparatus 1 does not transmit the M-SEARCH message to the terminal 03.

The terminal 02 having received the M-SEARCH message returns a response message to the relay apparatus 1. Meanwhile, when the terminal 02 is not a device terminal, the terminal 02 may not return a response message. Then, the relay apparatus 1 forwards the response message transmitted from the terminal 02 to the terminal 01. As a result, the terminal 01 recognizes that the device terminal 02 is present within a subnet. However, as described above, the relay apparatus 1 does not transmit the M-SEARCH message to the terminal 03. Accordingly, the terminal 01 does not receive the response message from the terminal 03. Therefore, although the terminal 03 is actually present within the subnet, the terminal 01 may not recognize the presence of the terminal 03.

Subsequently, the terminal 01 requests device definition information from a device terminal which is detected based on a response to the M-SEARCH message. That is, the terminal 01 transmits a device definition request message for requesting the device definition information of the terminal 02, to the relay apparatus 1. Then, the relay apparatus 1 forwards the device definition request message to the terminal 02.

When the terminal 02 receives the device definition request message, the terminal creates a response message including the device definition information of the terminal 02 and returns a response message to the relay apparatus 1. When the relay apparatus 1 receives the response message from the terminal 02, the relay apparatus changes the device definition information included in the message, if desired. For example, the relay apparatus 1 specifies a group in which a destination terminal of the response message participates, with reference to the group DB 17. In this example, the group “a” in which the terminal 01 participates is specified. Then, the relay apparatus 1 deletes descriptions of services other than services that may be provided to the specified group, from the device definition information. The relay apparatus 1 transmits the response message to the terminal 01.

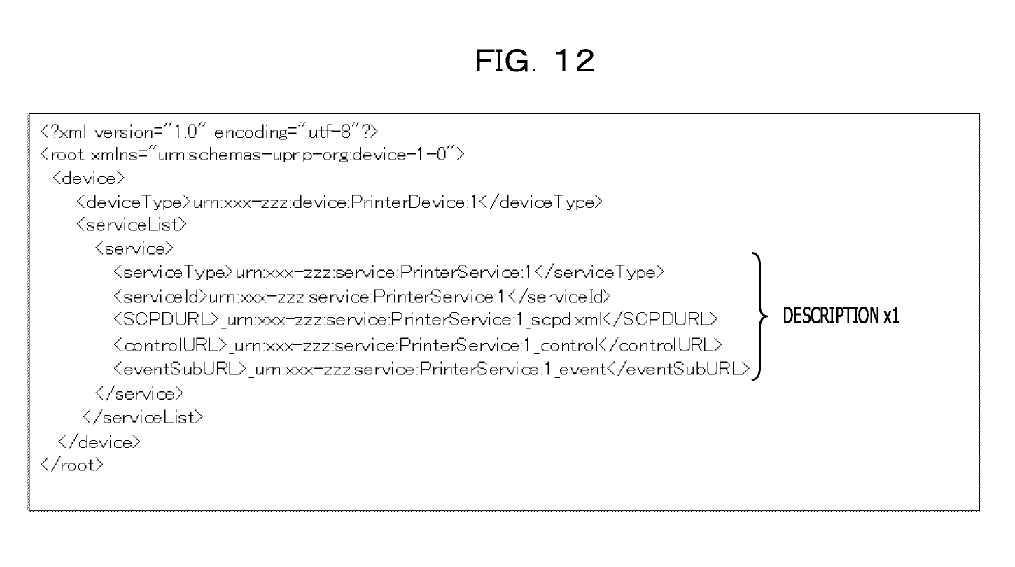

An example is illustrated below. When the terminal 02 receives the device definition request message, the terminal returns a response message including the device definition information illustrated in FIG. 8 to the relay apparatus 1. Here, a destination terminal (that is, the terminal 01) of the response message participates in the group “a”. In addition, the relay apparatus 1 recognizes that a facsimile service is not permitted to the group “a”, with reference to the access policy DB 19. Then, the relay apparatus 1 deletes a description of a service which is not permitted to the group “a”, from the device definition information illustrated in FIG. 8. That is, the description x2 on the facsimile service which is not permitted to the group “a” is deleted from the device definition information illustrated in FIG. 8. As a result, the device definition information is changed to a state illustrated in FIG. 12. The relay apparatus 1 transmits a response message including the device definition information illustrated in FIG. 12 to the terminal 01. That is, the terminal 01 receives the device definition information illustrated in FIG. 12.

Further, the terminal 01 requests service definition information on services that are listed within the received device definition information. That is, the terminal 01 transmits a service definition request message for requesting the service definition information to the relay apparatus 1. Then, the relay apparatus 1 forwards the service definition request message to the terminal 02.

When the terminal 02 receives the service definition request message, the terminal creates a response message including designated service definition information and returns the response message to the relay apparatus 1. When the relay apparatus 1 receives the response message from the terminal 02, the relay apparatus changes the service definition information included in the message, if desired. For example, the relay apparatus 1 specifies a group in which a destination terminal of the response message participates, with reference to the group DB 17. Then, the relay apparatus 1 deletes descriptions defining actions other than actions that may be provided to the specified group, from the service definition information. The relay apparatus 1 transmits the response message to the terminal 01.

An example is illustrated below. In this example, the terminal 01 receives the device definition information illustrated in FIG. 12, and thus recognizes that the terminal 02 provides a printer service. Then, the terminal 01 requests service definition information on the printer service from the terminal 02. Meanwhile, the terminal 01 may not recognize that the terminal 02 provides the facsimile service.

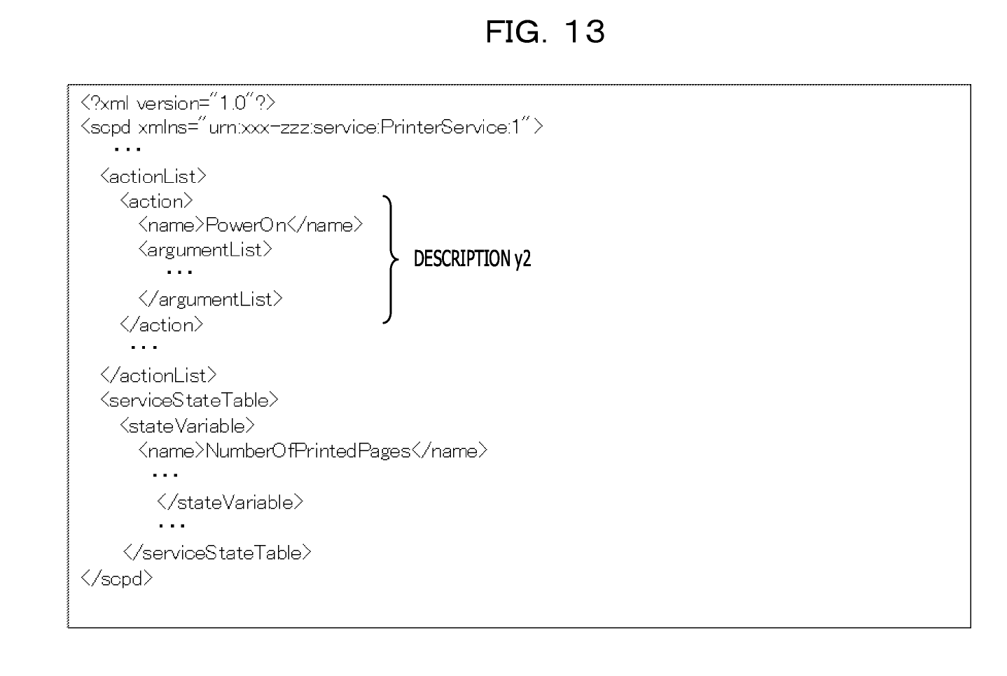

When the terminal 02 receives the service definition request message, the terminal returns a response message including the service definition information illustrated in FIG. 9 to the relay apparatus 1. Here, a destination terminal (that is, the terminal 01) of the response message participates in the group “a”. Then, the relay apparatus 1 deletes a description on an action which is not permitted to the group “a”, with reference to an access policy description in the service definition information. That is, the description y1 (that is, a description on a power-off operation) which is not permitted to the group “a” is deleted from the service definition information illustrated in FIG. 9. At this time, the relay apparatus 1 may delete the access policy description in the service definition information. As a result, the service definition information is changed to a state illustrated in FIG. 13. Then, the relay apparatus 1 transmits a response message including the service definition information illustrated in FIG. 13 to the terminal 01. That is, the terminal 01 receives the service definition information illustrated in FIG. 13.

The terminal 01 may request a service from the terminal 02, using the device definition information and the service definition information which are acquired in the above-described manner. In this case, the terminal 01 transmits a service request message to the relay apparatus 1, using the acquired device definition information and service definition information. The relay apparatus 1 forwards the service request message to the terminal 02. Then, the terminal 02 provides or executes a service in response to the service request message. Further, the terminal 02 transmits the response message to the relay apparatus 1, and the relay apparatus 1 transmits the response message to the terminal 01.

Meanwhile, when the terminal 01 secedes from a participating group, the terminal transmits a group secession request message to the relay apparatus 1. Then, in the relay apparatus 1, the terminal 01 is deleted from the group DB 17. Thereafter, the relay apparatus 1 returns a response message indicating the success of the secession to the terminal 01. Then, in the terminal 01, information on the group “a” is deleted from the terminal participation group DB 25.

In this manner, in the first embodiment, the terminal retrieval request (M-SEARCH) message transmitted from the terminal 01 is transmitted to only a terminal which belongs to the same group as the terminal 01 by the relay apparatus 1. Therefore, the terminal 01 may detect the presence of a device terminal which belongs to the same group as the terminal 01, but may not detect the presence of a device terminal which does not belong to the same group as the terminal 01. That is, the network system according to the first embodiment may hide the presence of a device terminal that does not belong to the same group as a controller terminal, from the controller terminal.

In addition, in the first embodiment, when device definition information/service definition information is transmitted from the terminal 02 to the terminal 01 in response to a device/service definition information request message, the relay apparatus 1 deletes a description which is not permitted to a group to which a transmission source terminal of the request message belongs, from the device definition information/service definition information. Therefore, the controller terminal may not acquire definition information which is not permitted to a group to which the controller terminal belongs. Here, the controller terminal may receive only a service relating to the acquired definition information. That is, the network system according to the first embodiment provides only a service which is permitted to a group to which a controller terminal belongs, to the controller terminal. Thus, an access control method is realized of providing a corresponding service in accordance with an attribute of a terminal that requests a service.

Meanwhile, the sequence illustrated in FIG. 11 is one example, and the embodiment is not limited to the sequence. For example, a device terminal may transmit a response message for each service with respect to a terminal retrieval request. In this case, the relay apparatus 1 may discard a response message including service information which is not permitted to a group to which a transmission source terminal of the terminal retrieval request belongs.

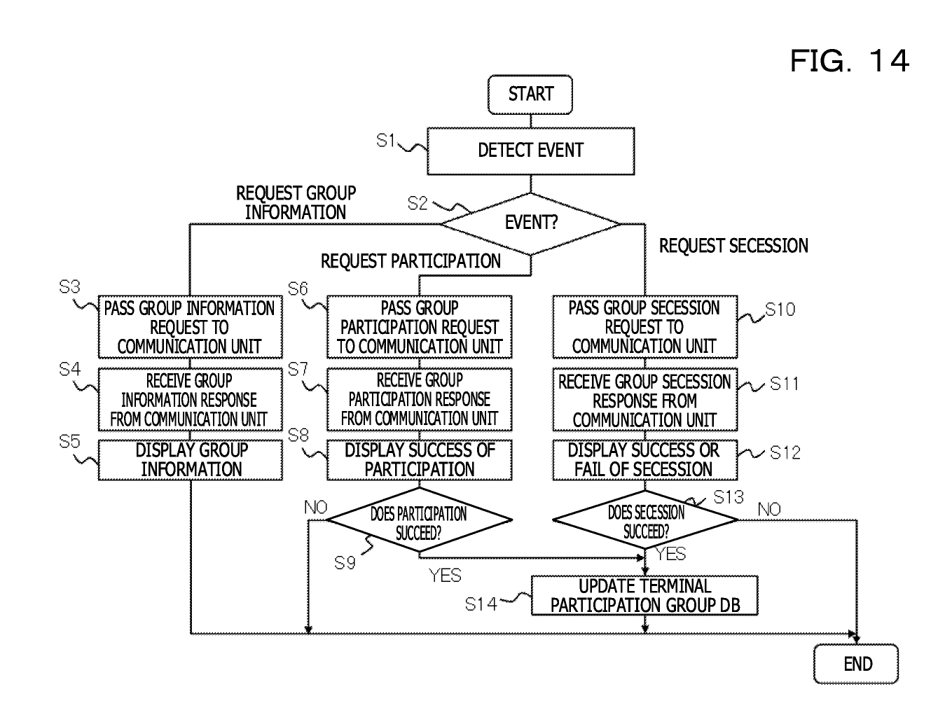

FIG. 14 is a flowchart illustrating the processing of the group processing unit 22. As illustrated in FIG. 2, the group processing unit 22 is provided in a terminal (controller terminal or device terminal).

In S1, the group processing unit 22 detects an event. For example, the event is given to the group processing unit 22 by a user's operation of a terminal. In S2, the group processing unit 22 determines a type of the event which is detected in S1. The group processing unit 22 executes processing corresponding to the type of the event.

When a group information request event is detected, the processing of the group processing unit 22 proceeds to S3. In S3, the group processing unit 22 generates a group information request message and passes the message to the communication unit 21. In this case, the group information request message is transmitted to the relay apparatus 1 by the communication unit 21. Then, the relay apparatus 1 returns a response message. The response message includes a group information response (that is, participation allowable group information) which indicates a group allowable for participation. The response message is received by the communication unit 21.

In S4, the group processing unit 22 receives the response message from the communication unit 21, and extracts the participation allowable group information from the response message. In S5, the group processing unit 22 displays the participation allowable group information on a display screen of a terminal. As a result, a list of groups in which the terminal may participate is displayed on the display screen. Meanwhile, when the terminal is not registered with the relay apparatus 1, the group processing unit 22 may not acquire the participation allowable group information from the relay apparatus 1. Alternatively, the group processing unit 22 receives information indicating that a group allowable for participation is not present, from the relay apparatus 1. In this case, the group processing unit 22 displays that a group allowable for participation is not present.

When a group participation request event is detected, the processing of the group processing unit 22 proceeds to S6. Meanwhile, for example, it is assumed that a user designates a desired group based on the participation allowable group information displayed in S5.

In S6, the group processing unit 22 generates a group participation request message and passes the message to the communication unit 21. The group participation request message includes a group ID for identifying a group which is designated by a user. The group participation request message is transmitted to the relay apparatus 1 by the communication unit 21. Then, the relay apparatus 1 determines whether to permit a participation request, and transmits a response message including the determination result. The response message is received by the communication unit 21.

In S7 and S8, the group processing unit 22 receives the response message from the communication unit 21 and acquires the determination result for the participation request from the response message. The group processing unit 22 displays the determination result for the participation request on the display screen.

In S9, the group processing unit 22 analyzes the determination result for the participation request. When the participation in the group designated by the user is permitted, in S14, the group processing unit 22 updates the terminal participation group DB 25. In this case, the group processing unit 22 registers information (a group name, a group ID, and the like), which indicates the designated group, with the terminal participation group DB 25. Meanwhile, when the participation in the designated group is not permitted, S14 is skipped.

When a group secession request event is detected, the processing of the group processing unit 22 proceeds to S10. Meanwhile, for example, a user designates a seceding group based on the participation allowable group information which is displayed in S5.

In S10, the group processing unit 22 generates a group secession request message and passes the message to the communication unit 21. The group secession request message includes a group ID for identifying a group which is designated by a user. The group secession request message is transmitted to the relay apparatus 1 by the communication unit 21. Then, the relay apparatus 1 determines whether to permit a secession request and returns a response message including the determination result. The response message is received by the communication unit 21.

In S11 and S12, the group processing unit 22 receives the response message from the communication unit 21 and acquires a determination result for the secession request from the response message. The group processing unit 22 displays the determination result for the secession request on the display screen.

In S13, the group processing unit 22 analyzes the determination result for the secession request. When the secession from a group designated by a user is permitted, in S14, the group processing unit 22 updates the terminal participation group DB 25. In this case, the group processing unit 22 deletes information (a group name, a group ID, and the like) which indicates the designated group from the terminal participation group DB 25. Meanwhile, when the secession from the designated group is not permitted, S14 is skipped.

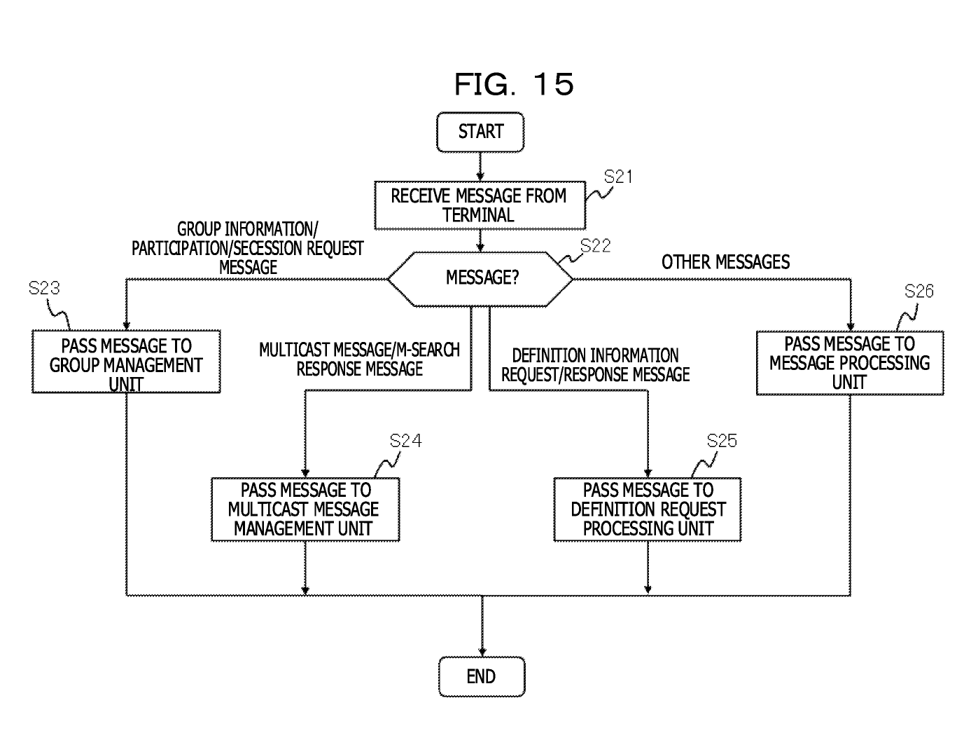

FIG. 15 is a flowchart illustrating the processing of the communication unit 11 of the relay apparatus. In S21 and S22, when the communication unit 11 receives a message from a terminal, the communication unit determines a type of the message. Then, the communication unit 11 executes processing corresponding to the type of the received message.

When the group information request message, the group participation request message, or the group secession request message is received, the processing of the communication unit 11 proceeds to S3. In this case, the communication unit 11 passes the received message to the group management unit 12.

When the multicast message (for example, terminal retrieval request message (M-SEARCH)) or the response message of the terminal retrieval request is received, the processing of the communication unit 11 proceeds to S4. In this case, the communication unit 11 passes the received message to the multicast message processing unit 13. Meanwhile, the communication unit 11 receives the terminal retrieval request message (M-SEARCH) from the controller terminal. In addition, the communication unit 11 receives the response message of the terminal retrieval request from the device terminal.

When the definition request message or the response message of the definition request message is received, the processing of the communication unit 11 proceeds to S5. In this case, the communication unit 11 passes the received message to the definition request message processing unit 14. Meanwhile, the definition request message includes the device definition request message and the service definition request message.

When other messages are received, the processing of the communication unit 11 proceeds to S6. In this case, the communication unit 11 passes the received message to the message processing unit 15. In addition, the communication unit 11 executes not only processing of receiving a message but also processing of transmitting a message. However, the processing of transmitting a message will not be described.

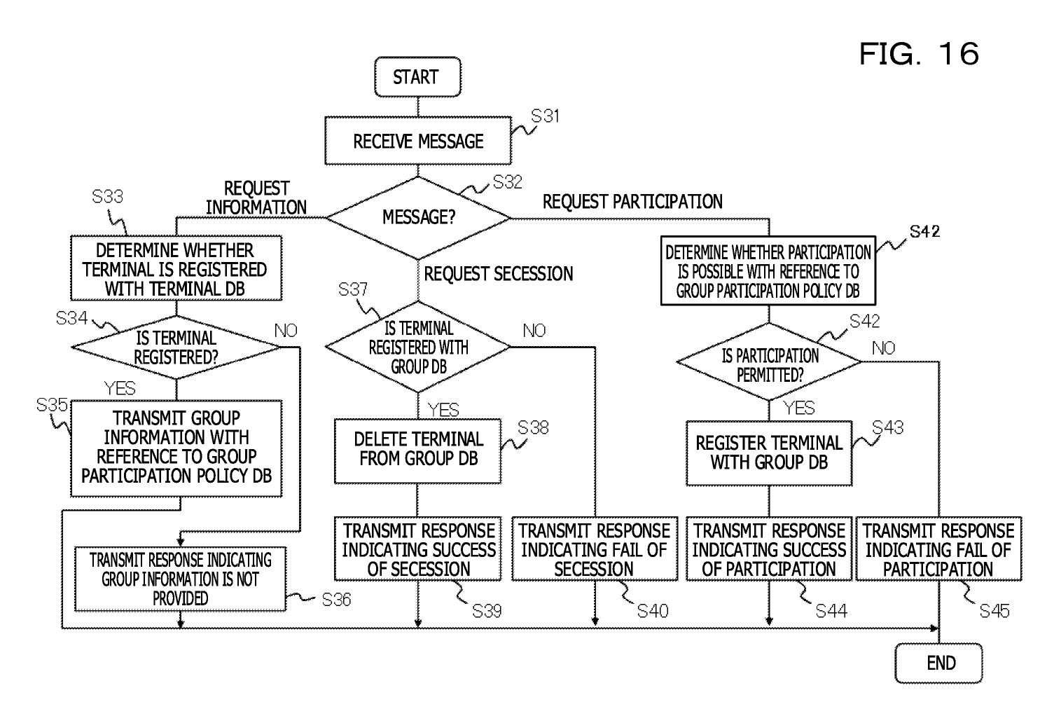

FIG. 16 is a flowchart illustrating the processing of the group management unit 12. As illustrated in FIG. 2, the group management unit 12 is provided in the relay apparatus 1.

In S31 and S32, the group management unit 12 receives a message transmitted from a terminal, through the communication unit 11. However, as described above with reference to FIG. 15, the group management unit 12 receives the group information request message, the group participation request message, or the group secession request message. Then, the group management unit 12 executes processing corresponding to the type of the received message.

When the group information request message is received, the processing of the group management unit 12 proceeds to S33. In S33 and S34, the group management unit 12 determines whether a transmission source terminal of the group information request message is registered with the terminal DB 18. At this time, for example, the group management unit 12 retrieves the terminal DB 18 using a transmission source IP address of the received group information request message, and thus performs the determination of S33.

When the transmission source terminal is registered with the terminal DB 18, in S35, the group management unit 12 extracts participation allowable group information corresponding to the terminal with reference to the group participation policy DB 16. Then, the group management unit 12 transmits a response message including the participation allowable group information to the transmission source terminal of the group information request message.

When the transmission source terminal is not registered with the terminal DB 18, in S36, the group management unit 12 transmits a response message including information indicating that there is no group in which the terminal may participate. Then, the group management unit 12 transmits the response message to the transmission source terminal of the group information request message.

When the group secession request message is received, the processing of the group management unit 12 proceeds to S37. Here, the group secession request message includes information for designating a seceding group.

In S37, the group management unit 12 determines whether the transmission source terminal of the group secession request message is registered on a record corresponding to a designated group in the group DB 17. When the terminal is registered with the group DB 17, in S38, the group management unit 12 deletes a terminal ID of the terminal from the corresponding record of the group DB 17. Further, in S39, the group management unit 12 transmits a response message including information indicating that the secession from the group succeeds, to the transmission source terminal of the group secession request message. On the other hand, when the terminal is not registered with the group DB 17, in S40, the group management unit 12 transmits a response message including information indicating the secession from the group fails, to the transmission source terminal of the group secession request message.

When the group participation request message is received, the processing of the group management unit 12 proceeds to S41. Here, the group participation request message includes information for designating a participating group.

In S41 and S42, the group management unit 12 determines whether to permit to cause the transmission source terminal of the group participation request message to participate in the designated group, with reference to the group participation policy DB 16. When the participation is permitted, in S43, the group management unit 12 registers a terminal ID for identifying the terminal with a corresponding record of the group DB 17. Further, in S44, the group management unit 12 transmits a response message including information indicating that the participation in the group succeeds, to the transmission source terminal of the group participation request message. On the other hand, when the participation is not permitted, in S45, the group management unit 12 transmits a response message including information indicating that the participation in the group fails, to the transmission source terminal of the group participation request message.

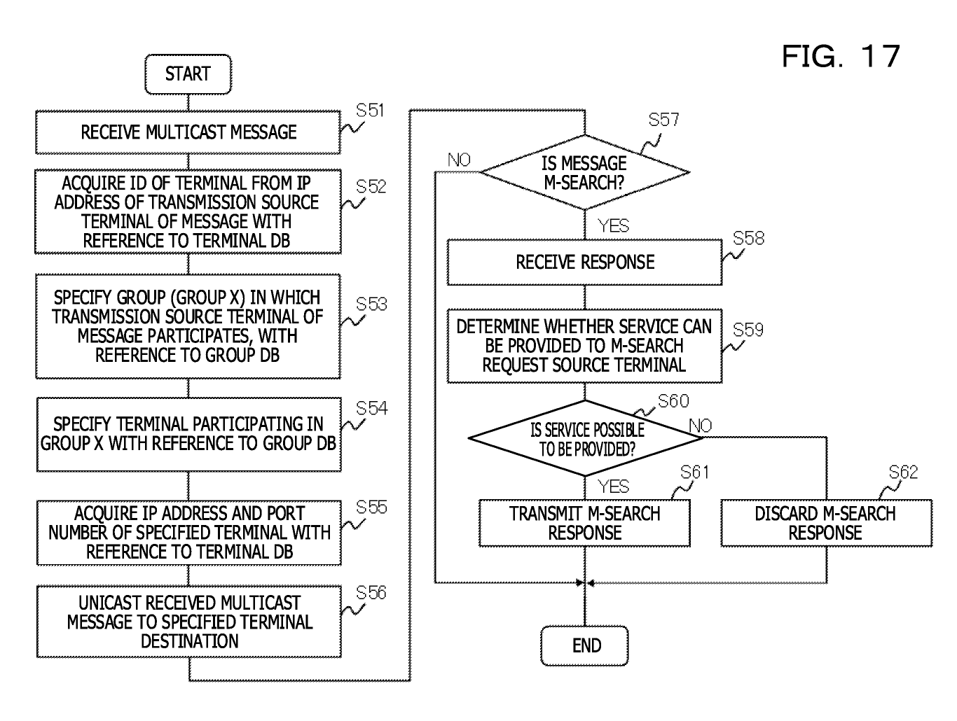

FIG. 17 is a flowchart illustrating the processing of the multicast message processing unit 13. As illustrated in FIG. 2, the multicast message processing unit 13 is provided in the relay apparatus 1.

In S51, the multicast message processing unit 13 receives a multicast message from a terminal. A destination port number (that is, value indicating multicast) which is designated in advance is set in the multicast message. Meanwhile, a terminal retrieval request (M-SEARCH) message transmitted from the terminal is a multicast message.

In S52, the multicast message processing unit 13 acquires a terminal ID of a transmission source terminal of the received message with reference to the terminal DB 18 using a transmission source IP address of the message.

In S53, the multicast message processing unit 13 specifies a group in which the transmission source terminal of the message participates, with reference to the group DB 17 using the acquired terminal ID. In the following description, the group specified in this manner will be referred to as a “group X”. That is, the group X indicates a group in which the transmission source terminal of the received multicast message participates.

In S54, the multicast message processing unit 13 specifies other terminals participating in the group X with reference to the group DB 17. That is, terminals other than the terminal which is the transmission source of the multicast message are specified in the terminals participating in the group X. In S55, the multicast message processing unit 13 acquires an IP address and a port number of each terminal which is specified in S54, with reference to the terminal DB 18.

In S56, the multicast message processing unit 13 generates a unicast message having the same contents as those of the received multicast message, and transmits the unicast message to the IP address/port number acquired in S55. That is, a message converted into a unicast format is transmitted to each terminal belonging to the group X. Meanwhile, when the transmission source terminal of the multicast message participates in a plurality of groups, S54 to S56 are executed on each group. However, the same message is not repeatedly transmitted to a device terminal that participates in a plurality of groups.

In S57, the multicast message processing unit 13 determines whether the received multicast message is a terminal retrieval request (M-SEARCH) message. When the received multicast message is the M-SEARCH message, the processing of the multicast message processing unit 13 proceeds to S58. On the other hand, when the received multicast message is not the M-SEARCH message, the processing of the multicast message processing unit 13 is terminated.

The device terminal having received the M-SEARCH message returns a response message to the relay apparatus 1. Here, the M-SEARCH message is transmitted to only a terminal participating in the group X by S54 to S56. Therefore, only a device terminal participating in the group X returns an M-SEARCH response message to the relay apparatus 1. At this time, the device terminal transmits the M-SEARCH response message indicating the presence of the terminal. In addition, the device terminal transmits the M-SEARCH response message with respect to each service capable of being provided. In this case, service type information for identifying a service is written in a search target (ST) field of the response message.

Therefore, in S58, the multicast message processing unit 13 receives the M-SEARCH response message from the device terminal. Subsequently, in S59 and S60, the multicast message processing unit 13 acquires a value (that is, service type information) of the ST field of the received M-SEARCH response message. Then, the multicast message processing unit 13 determines whether service information may be provided to the transmission source terminal of the M-SEARCH message, with reference to the access policy DB 19 using the acquired value of the ST field. For example, it is assumed that the transmission source terminal of the M-SEARCH message participates in only the group “a”. In addition, it is assumed that the relay apparatus 1 has the access policy DB 19 illustrated in FIG. 6. In this case, the printer service is permitted, but the facsimile service is not permitted.

When the service information is permitted to be provided, in S61, the multicast message processing unit 13 transmits the M-SEARCH response message including the service information to the transmission source terminal of the M-SEARCH message. On the other hand, when the service information is not permitted to be provided, in S62, the multicast message processing unit 13 discards the M-SEARCH response message including the service information. Meanwhile, the M-SEARCH response message indicating the presence of a terminal is transmitted to the transmission source terminal of the M-SEARCH message.

In addition, in S59, when service type information is written in the ST field of the M-SEARCH response message (that is, for example, when the ST field includes a word of “service”), the multicast message processing unit 13 refers to the access policy DB 19. When the service type information written in the ST field is registered with the access policy DB 19, the multicast message processing unit 13 limits a provision destination of a service in accordance with a corresponding access policy. On the other hand, when the service type information is not written in the ST field of the M-SEARCH response message, the multicast message processing unit 13 transmits the M-SEARCH response message to a terminal which is a transmission source of the M-SEARCH message without limiting the provision destination of the service.

Examples of a terminal retrieval request and a response thereto will be described below. In the following description, it is assumed that the controller terminal 01 executes the terminal retrieval request in the network system illustrated in FIG. 1.

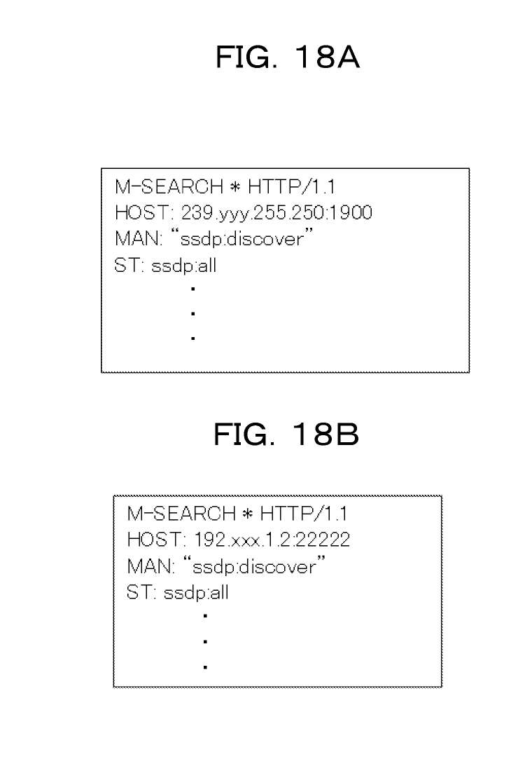

FIG. 18A illustrates a portion of contents of the terminal retrieval request (M-SEARCH) message transmitted from the controller terminal 01. Here, “239.yyy.255.250” of a Host field indicates an IP address for multicast communication of an M-SEARCH message. In addition, “1900” of the Host field indicates a port number for multicast communication. Further, “ssdp:all” of an ST field designates the retrieval of all terminals and services within a subnet.

The relay apparatus 1 specifies a group in which a transmission source terminal (that is, the controller terminal 01) of the M-SEARCH message participates, with reference to the terminal DB 18 and the group DB 17. Thus, the group “a” is specified. Subsequently, the relay apparatus 1 specifies a terminal (except for the controller terminal 01) which participates in the group “a”, with reference to the group DB 17. Thus, the terminal 02 is detected. Then, the relay apparatus 1 acquires an IP address and a port number of the terminal 02 with reference to the terminal DB 18. In the example illustrated in FIG. 5, “IP address:192.xxx.1.2” and “port number:22222” are obtained. Then, the relay apparatus 1 creates an M-SEARCH message in a unicast format to be transmitted to the terminal 02.

As illustrated in FIG. 18B, the contents of the unicast M-SEARCH message are the same as those of the M-SEARCH message received from the controller terminal 01. However, the IP address and the port number of the terminal 02 which are acquired from the terminal DB 18 are set in a Host field of the unicast M-SEARCH message. The relay apparatus 1 transmits the unicast M-SEARCH message to the terminal 02. The terminal 03 illustrated in FIG. 1 does not participate in the group “a”. Accordingly, the relay apparatus 1 does not transmit the unicast M-SEARCH message to the terminal 03.

The terminal 02 may operate as a device terminal. Accordingly, the terminal 02 returns an M-SEARCH response message corresponding to the unicast M-SEARCH message to the relay apparatus 1. At this time, the terminal 02 transmits, to the relay apparatus 1, an M-SEARCH response message that notifies the presence of the terminal 02 and an M-SEARCH response message that notifies the presence of a service capable of being provided. Here, the terminal 02 may provide the following two services.

printer service (urn:xxx-zzz:service:PrinterSevice:1)

facsimile service (urn:xxx-zzz:service:FaxSevice:1)

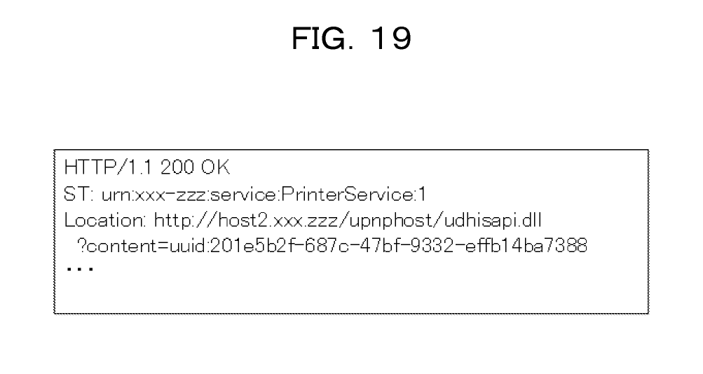

The M-SEARCH response message that notifies the presence of a service is generated for each service. That is, the terminal 02 transmits, to the relay apparatus 1, an M-SEARCH response message that notifies the presence of a printer service and an M-SEARCH response message that notifies the presence of a facsimile service. For example, FIG. 19 illustrates a portion of the contents of the M-SEARCH response message that notifies the presence of a printer service. At this time, information for identifying a service is set in an ST field of the M-SEARCH response message.

The relay apparatus 1 determines whether the M-SEARCH response message transmitted from the terminal 02 may be forwarded to the controller terminal 01. For example, as illustrated in FIG. 6, the printer service is permitted to the group “a”. Therefore, the relay apparatus 1 forwards the M-SEARCH response message that notifies the presence of the printer service, to the controller terminal 01. On the other hand, as illustrated in FIG. 6, a facsimile service is not permitted to the group “a”. Accordingly, the relay apparatus 1 discards the M-SEARCH response message that notifies the presence of the facsimile service without forwarding the message to the controller terminal 01. Accordingly, the controller terminal 01 detects the presence of the printer service, but may not detect the presence of the facsimile service. Meanwhile, the M-SEARCH response message notifying the presence of the terminal 02 is forwarded to the controller terminal 01.

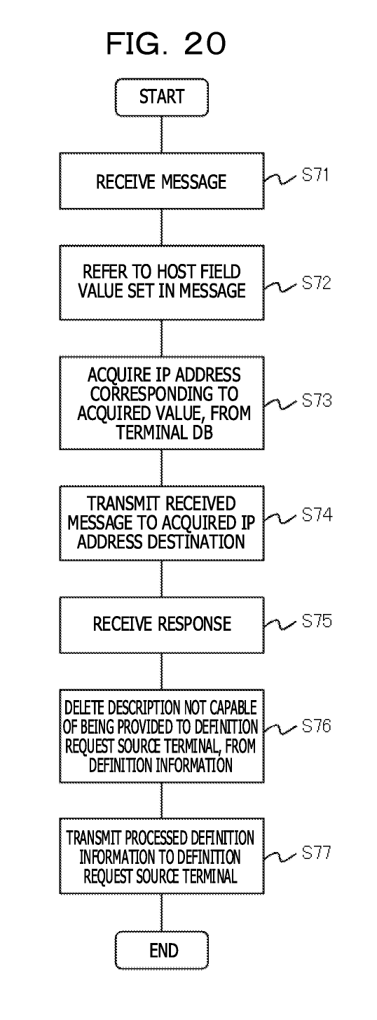

FIG. 20 is a flowchart illustrating the processing of the definition request message processing unit 14. As illustrated in FIG. 2, the definition request message processing unit 14 is provided in the relay apparatus 1.

In S71, the definition request message processing unit 14 receives a definition request message (HTTP GET message) which is transmitted from a terminal. Meanwhile, the definition request message is a device definition request message or a service definition request message.

In S72, the definition request message processing unit 14 refers to a Host field of the definition request message received in S71. A host name of a destination is set in the Host field. In S73, the definition request message processing unit 14 acquires an IP address corresponding to the host name from the terminal DB 18. In S74, the definition request message processing unit 14 transmits the received definition request message to the IP address acquired in S73.

A device terminal having received the definition request message transmits a response message to the relay apparatus 1. The response message includes requested definition information (device definition information or service definition information). In S75, the definition request message processing unit 14 receives the response message transmitted from the device terminal.

In S76, the definition request message processing unit 14 determines whether a description not capable of being provided to a transmission source terminal of the definition request message is included in the definition information received from the device terminal, with reference to the access policy DB 19. When the definition information includes a non-permitted description, the definition request message processing unit 14 deletes the non-permitted description from the definition information.

In S77, the definition request message processing unit 14 transmits a response message to the transmission source terminal of the definition request message. When deletion processing is executed in S76, the definition information from which the non-permitted description is deleted is transmitted to the transmission source terminal of the definition request message.

Next, an example of a procedure of causing a controller terminal to request definition information from a device terminal will be described. In the following description, it is assumed that the controller terminal 01 receives the M-SEARCH response message illustrated in FIG. 19 from the device terminal 02 in a terminal retrieval procedure.

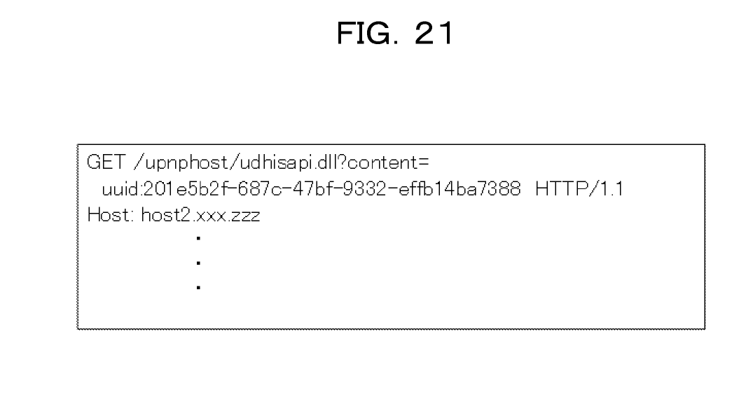

The controller terminal 01 generates a device definition request message (HTTP GET message) and transmits the message to the device terminal 02. At this time, a URL set in a Location field of the M-SEARCH response message illustrated in FIG. 19 is designated. The URL designates a location in which the device definition information is stored. An example of the generated device definition request message is illustrated in FIG. 21.

The device definition request message is forwarded by the relay apparatus 1 and is received by the device terminal 02. Then, the device terminal 02 returns a response message including the device definition information illustrated in FIG. 8 to the relay apparatus 1.

The relay apparatus 1 searches for a <serviceType> tag in the device definition information and acquires service type information described in the tag. Then, the relay apparatus 1 refers to the access policy DB 19, using the acquired service type information. In this example, as illustrated in FIG. 6, the printer service is permitted to the groups “a” and “b”, but the facsimile service is permitted to only the group “b”. On the other hand, the controller terminal 01 participates in only the group “a”. Therefore, the relay apparatus 1 determines that the printer service is permitted to the controller terminal 01, but the facsimile service is not permitted thereto.

In this case, the relay apparatus 1 deletes a description x2 (from <service> to </service>) which relate to the facsimile service in the device definition information. As a result, the device definition information is processed to a state illustrated in FIG. 12. Then, the relay apparatus 1 transmits a response message including the device definition information processed in this manner, to the controller terminal 01.

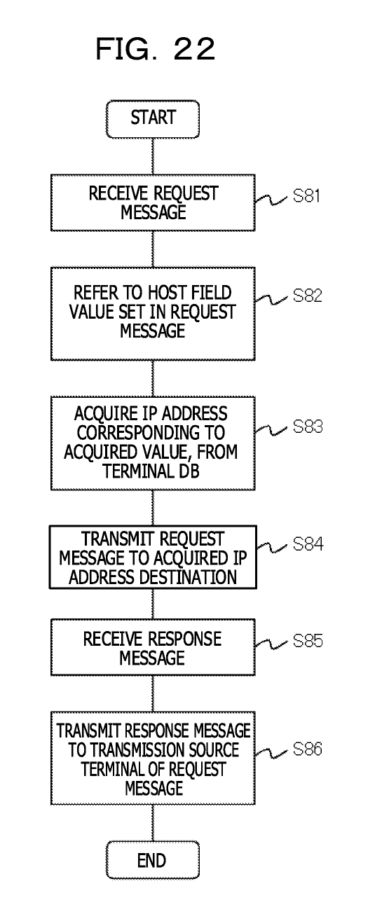

FIG. 22 is a flowchart illustrating the processing of the message processing unit 15. As illustrated in FIG. 2, the message processing unit 15 is provided in the relay apparatus 1.

In S81, the message processing unit 15 receives a message from a terminal. For example, the received message is a request message for requesting the execution of a service/action. In S82, the message processing unit 15 refers to a value of a Host field of the request message. In S83, the message processing unit 15 acquires an IP address corresponding to the value of the Host field from the terminal DB 18. Then, in S84, the message processing unit 15 transmits the request message to the IP address acquired in S83. A device terminal having received the request message executes a corresponding process. It is assumed that the device terminal returns the response message to the relay apparatus 1.

In S85, the message processing unit 15 receives the response message which is transmitted from the device terminal. In S86, the message processing unit 15 forwards the response message to a transmission source terminal of the request message.

### Second Embodiment

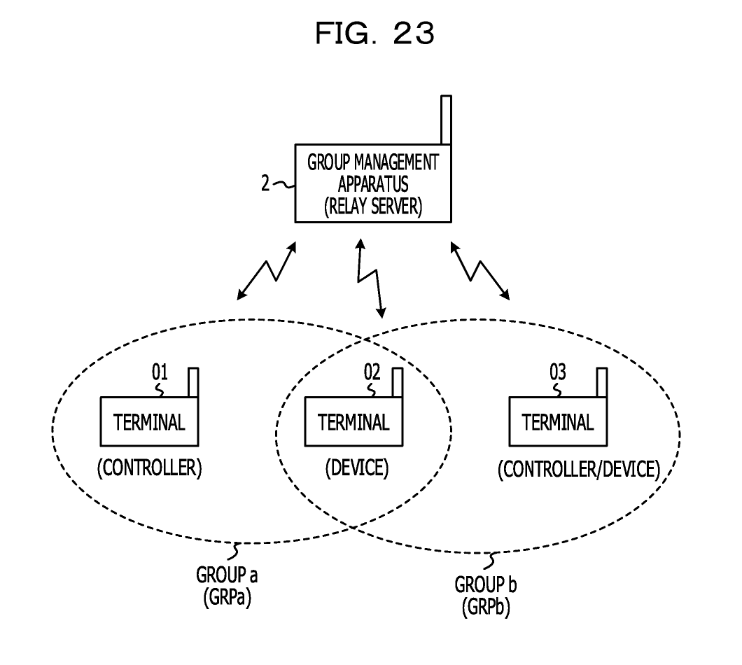

FIG. 23 illustrates an example of a network system according to a second embodiment. The network system has a group management apparatus (relay server) 2. In this example, three terminals 01 to 03 are connected to the network system.

In the second embodiment, each terminal ascertains other terminals that participate in the same group as the terminal. Therefore, when the device terminal receives a terminal retrieval request message from a controller terminal, the device terminal may determine whether the controller terminal participates in the same group as the terminal. When the device terminal determines that the controller terminal does not participate in the same group as the device terminal, the device terminal does not return a response message to the received terminal retrieval request message. Accordingly, the device terminal may hide its own presence or the presence of a service capable of being provided, from the controller terminal.

In addition, even when the controller terminal participates in the same group as the device terminal, the device terminal may control a message so as not to transmit information which is not permitted to the group. For example, in a case where a provision destination of definition information (device definition information, service definition information, or the like) is limited, when a disclosure destination for a state variable and the like is limited, the device terminal may control access from the controller terminal for each group.

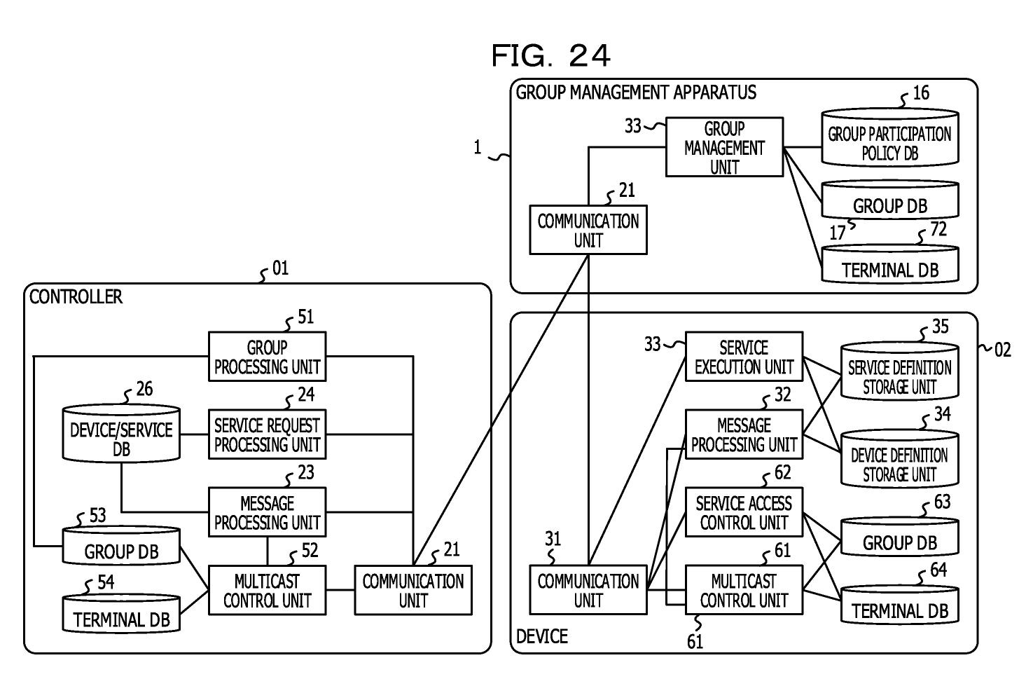

FIG. 24 is a diagram illustrating functions of a group management apparatus, a controller terminal, and a device terminal. A wireless link between the group management apparatus 2 and the controller terminal 01 and a wireless link between the group management apparatus 2 and the device terminal 02 are set if desired.

The group management apparatus 2 includes a communication unit 11, a group management unit 41, a group participation policy DB 16, a group DB 17, and a terminal DB 42. Meanwhile, the communication unit 11, the group participation policy DB 16, and the group DB 17 that are provided in the group management apparatus 2 are substantially the same as the corresponding components provided in the relay apparatus 1 of the first embodiment, and thus the description thereof will be omitted.

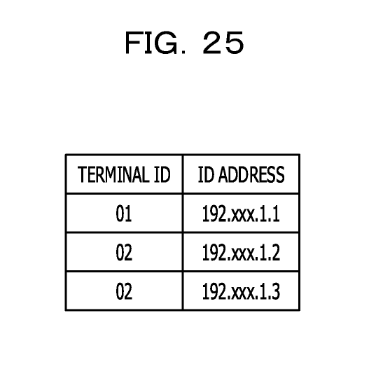

The group management unit 41 is similar to the group management unit 12 of the first embodiment, but has some different functions. The processing of the group management unit 41 will be described later with reference to a flowchart. As illustrated in FIG. 25, IP addresses of terminals present within a subnet are stored in the terminal DB 42. Meanwhile, the terminal DB 42 may be configured in the same manner as the terminal DB 18 in the first embodiment which is illustrated in FIG. 5.

A controller terminal of the second embodiment includes a communication unit 21, a message processing unit 23, a service request processing unit 24, a device/service DB 26, a group processing unit 51, a multicast control unit 52, a group DB 53, and a terminal DB 54. The communication unit 21, the message processing unit 23, the service request processing unit 24, and the device/service DB 26 are substantially the same as the corresponding components provided in the controller terminal of the first embodiment, and thus the description thereof will be omitted.

The group processing unit 51 requests the participation in a designated group or the secession from a designated group, from the group management apparatus 2. The group processing unit 51 updates the group DB 53 based on a response to the request. In addition, when a terminal is added to a group in which the group processing unit 51 participates or when the terminal secedes from the group, the group processing unit updates the group DB 53.

The multicast control unit 52 determines whether a transmission source terminal of a received multicast message (except for a terminal retrieval request message) participates in the same group as the multicast control unit. When the transmission source terminal participates in the same group as the multicast control unit, the multicast control unit 52 passes the received message to the message processing unit 23. On the other hand, when the transmission source terminal does not participate in the same group as the multicast control unit, the multicast control unit 52 discards the received message.

The group DB 53 manages a terminal which is present within each group in which a local terminal participates. For example, when the terminal 01 participates in a group “a”, the group processing unit 51 generates a record corresponding to the group “a” in the group DB 51. Therefore, the group DB 51 may realize functions in a similar manner to the terminal participation group DB 25 according to the first embodiment. In addition, when another terminal participates in the group “a”, the group processing unit 51 registers a terminal ID of the terminal with the record corresponding to the group “a” within the group DB 51, based on a notification from the group management apparatus 2.

The terminal DB 54 is substantially the same as the terminal DB 54 provided in the group management apparatus 2. However, only an IP address of a terminal within a group in which the terminal participates may be stored in the terminal DB 54 provided in the terminal.

As illustrated in FIG. 24, the device terminal of the second embodiment includes a communication unit 31, a message processing unit 32, a service execution unit 33, a device definition storage unit 34, a service definition storage unit 35, a multicast control unit 61, a service access control unit 62, a group DB 63, and a terminal DB 64. In addition, although not illustrated in the drawing, similarly to the controller terminal, the device terminal includes the group processing unit 51. Meanwhile, the communication unit 31, the message processing unit 32, the service execution unit 33, the device definition storage unit 34, and the service definition storage unit 35 are substantially the same as the corresponding components provided in the device terminal of the first embodiment, and thus the description thereof will be omitted.

The multicast control unit 61 determines whether a transmission source terminal of a received multicast message (including a terminal retrieval request message) participates in the same group as the multicast control unit. When the transmission source terminal participates in the same group as the multicast control unit, the multicast control unit 61 passes the received message to the message processing unit 32. On the other hand, when the transmission source terminal does not participate in the same group as the multicast control unit, the multicast control unit 61 discards the received message.

The service access control unit 62 executes desired processing on a terminal retrieval request and a definition information request. For example, when a response message to the terminal retrieval request includes information on a service which is not permitted to a group in which a transmission source terminal of the terminal retrieval request participates, the service access control unit 62 discards the response message without transmitting the message. In addition, when definition information corresponding to the definition information request includes a description which is not permitted to a group in which a transmission source terminal of the definition information request participates, the service access control unit 62 deletes the non-permitted description from the definition information.

The group DB 63 is substantially the same as the group DB 17 provided in the group management apparatus 2 or the group DB 53 provided in the controller terminal. In addition, the terminal DB 64 is substantially the same as the terminal DB 42 provided in the group management apparatus 2 or the terminal DB 54 provided in the controller terminal.

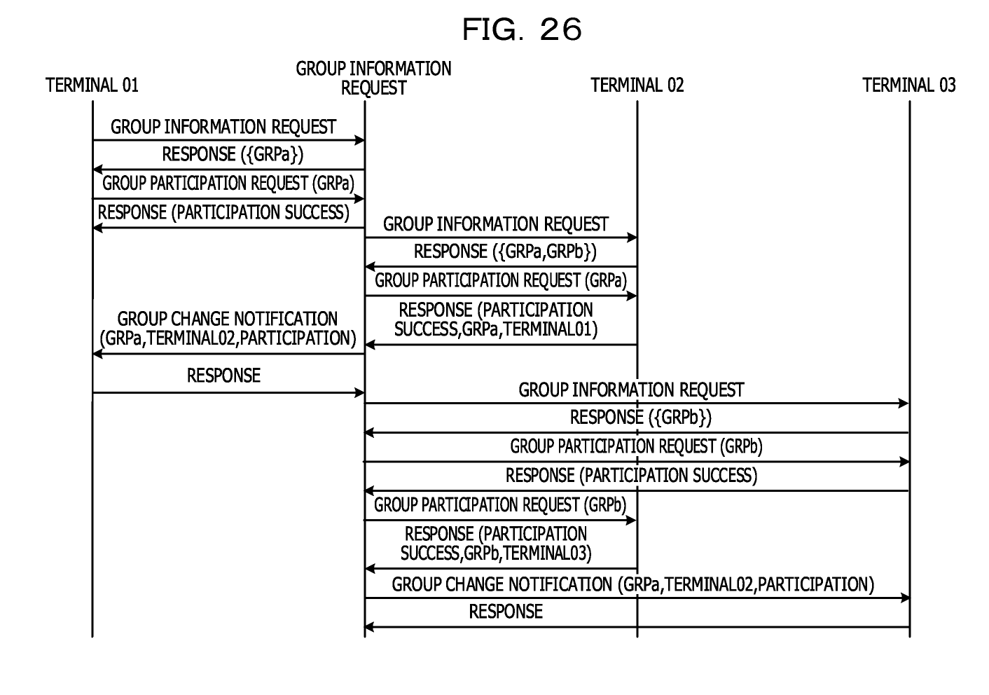

FIG. 26 illustrates an example of a group participation procedure in the second embodiment. Herein, it is assumed that each of the terminals 01 to 03 illustrated in FIG. 23 participates in one or a plurality of groups. In addition, the group management apparatus 2 has the group participation policy DB 16 illustrated in FIG. 3.

The group participation procedure in the second embodiment is similar to the procedure in the first embodiment which is illustrated in FIG. 10. For example, a procedure of causing the terminal 01 to request group information from the group management apparatus 2 and a procedure of causing the terminal 01 to designate the group “a” and to transmit a group participation request to the group management apparatus 1 are substantially the same as those in the first embodiment which are illustrated in FIG. 10.

However, in the second embodiment, when a configuration of a certain group changes, each terminal participating in the group is notified of the change. For example, as illustrated in FIG. 26, the terminal 02 transmits a group participation request for requesting the participation in the group “a”, to the group management apparatus 2. At this time, the terminal 01 participates in the group “a” in advance. For this reason, information of the terminal 01 that participates in the group “a” in advance is notified by a group participation response transmitted to the terminal 02. Further, the group management apparatus 2 notifies the terminal 01 of the terminal 02 having participated in the group “a”, using the group change notice. Therefore, each terminal may recognize other terminals participating in the group in which the terminal participates.

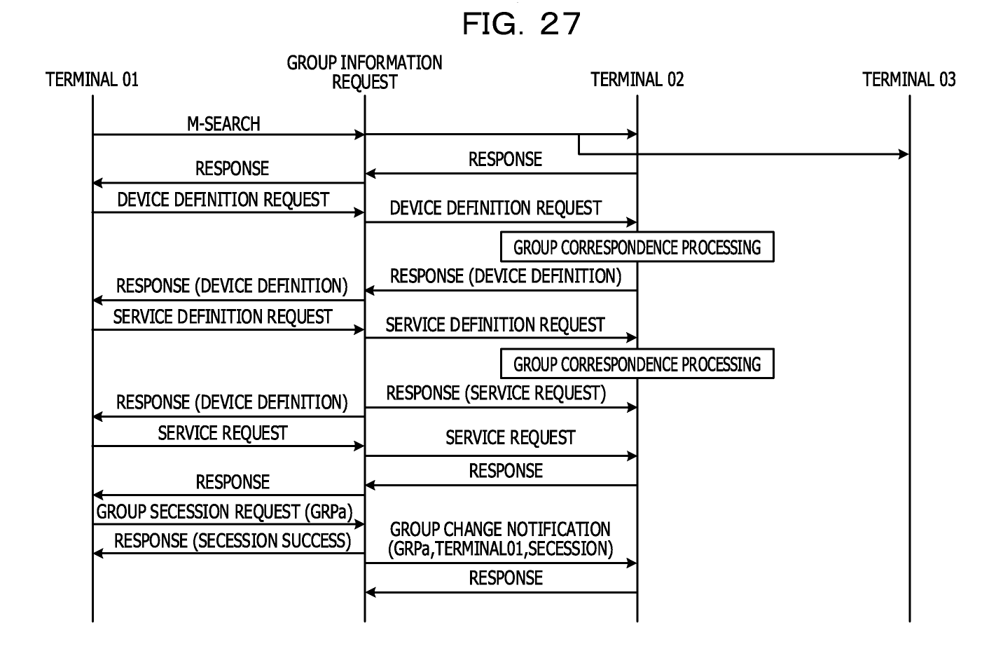

FIG. 27 illustrates an example of a service request procedure according to the second embodiment. In this example, it is assumed that the terminal 01 requests a service from the terminal 02. Meanwhile, the terminal 01 participates in the group “a” by the procedure illustrated in FIG. 26, but does not participate in the group “b”. In addition, the terminal 02 participates in the group “a” and the group “b”, and the terminal 03 participates in only the group “b”.

The terminal 01 transmits a terminal retrieval request (M-SEARCH) message to the group management apparatus 2. The M-SEARCH message is a multicast message. Meanwhile, the group management apparatus 2 provides a relay server function of relaying a message between terminals, in addition to the group management function described with reference to FIG. 26.

When the group management apparatus 2 receives the M-SEARCH message from the terminal 01, the group management apparatus multicast-forwards the M-SEARCH message to all terminals within a subnet, in contrast to the relay apparatus 1 of the first embodiment. Therefore, as illustrated in FIG. 27, the M-SEARCH message is received by the terminal 02 and the terminal 03.

The terminal 02 detects a group in which a transmission source terminal of the M-SEARCH message participates, with reference to the group DB 63. In this example, the participation of the transmission source terminal (that is, the terminal 01) of the M-SEARCH message in the group “a” is detected. Here, the terminal 02 also participates in the group “a”. Therefore, the terminal 02 returns the M-SEARCH response message to the group management apparatus 2. The group management apparatus 2 forwards the M-SEARCH response message to the terminal 01. As a result, the terminal 01 recognizes the presence of the terminal 02 that participates in the same group as the terminal 01.

On the other hand, the terminal 03 does not participate in the group “a”. In this case, the terminal 03 discards the received M-SEARCH message without returning the M-SEARCH response message. Therefore, the terminal 01 may not recognize the presence of the terminal 03.

Meanwhile, a device terminal having received the M-SEARCH message may control whether to return an M-SEARCH response message, for each service. For example, the terminal 02 may transmit an M-SEARCH response message indicating that a printer service permitted to the group “a” is present, and may not transmit an M-SEARCH response message indicating that a facsimile service is not permitted to the group “a” is present.

Subsequently, similarly to the first embodiment, the terminal 01 transmits a device definition request message for requesting device definition information of the terminal 02 to the group management apparatus 2. Then, the group management apparatus 2 forwards the device definition request message to the terminal 02.

When the terminal 02 receives the device definition request message, the terminal creates a response message including the device definition information of the terminal 02 and transmits the message to the group management apparatus 2. At this time, the terminal 02 executes a group correspondence process. That is, the terminal 02 detects a group in which a transmission source terminal of the device definition request message participates. In this example, the participation of the transmission source terminal (that is, the terminal 01) of the device definition request message in the group “a” is detected. In this case, the terminal 02 deletes a description which is not permitted to the group “a”, from the device definition information of the terminal 02. Then, the terminal 02 transmits a response message including the device definition information after the group correspondence processing to the group management apparatus 2. The group management apparatus 2 forwards the response message to the terminal 01.

Therefore, only information permitted to a group in which the terminal 01 participates is provided to the terminal 01. That is, a device terminal (herein, the terminal 02) may limit information to be provided, in accordance with an attribute of the transmission source terminal of the device definition request message.

Thereafter, the terminal 01 requests service definition information on services that are listed within the received device definition information. Meanwhile, a procedure of the service definition request is similar to that of the device definition request, and the description thereof will be omitted.

The terminal 01 may request the execution of a service/action from the terminal 02, using the device definition information and the service definition information which are acquired in the above-described manner. In this case, the terminal 01 transmits the service request message to the group management apparatus 2, using the acquired device definition information and service definition information. The group management apparatus 2 forwards the service request message to the terminal 02. Then, the terminal 02 provides or executes a service in response to the service request message. Further, the terminal 02 forwards a response message to the terminal 01 through the group management apparatus 2.

Meanwhile, when the terminal 01 secedes from a participating group, the terminal transmits a group secession request message to the group management apparatus 2. Then, in the group management apparatus 2, the terminal 01 is deleted from the group DB 17. Thereafter, the relay apparatus 1 returns a response message indicating the success of the secession to the terminal 01. Then, in the terminal 01, information on the group “a” is deleted from the group DB 53.

Further, the group management apparatus 2 notifies terminals within the group “a” of the change in the configuration of the group “a”. In this example, the group management apparatus 2 notifies the terminal 02 of the secession of the terminal 01 from the group “a”, using the group change notice.

As described above, in the second embodiment, when the transmission source terminal of the terminal retrieval request does not participate in the same group as a device terminal, the device terminal does not return a response message. Accordingly, the network system according to the second embodiment may hide the presence of the device terminal that does not belong to the same group as a controller terminal, from the controller terminal.

In addition, in the second embodiment, the device terminal deletes a description which is not permitted to the transmission source terminal of the definition information request message, from the device definition information/service definition information. That is, only the device definition information/service definition information permitted to a group in which the controller terminal participates is provided to the controller terminal. Thus, an access control method is realized of providing a corresponding service in accordance with an attribute of a terminal that requests a service.

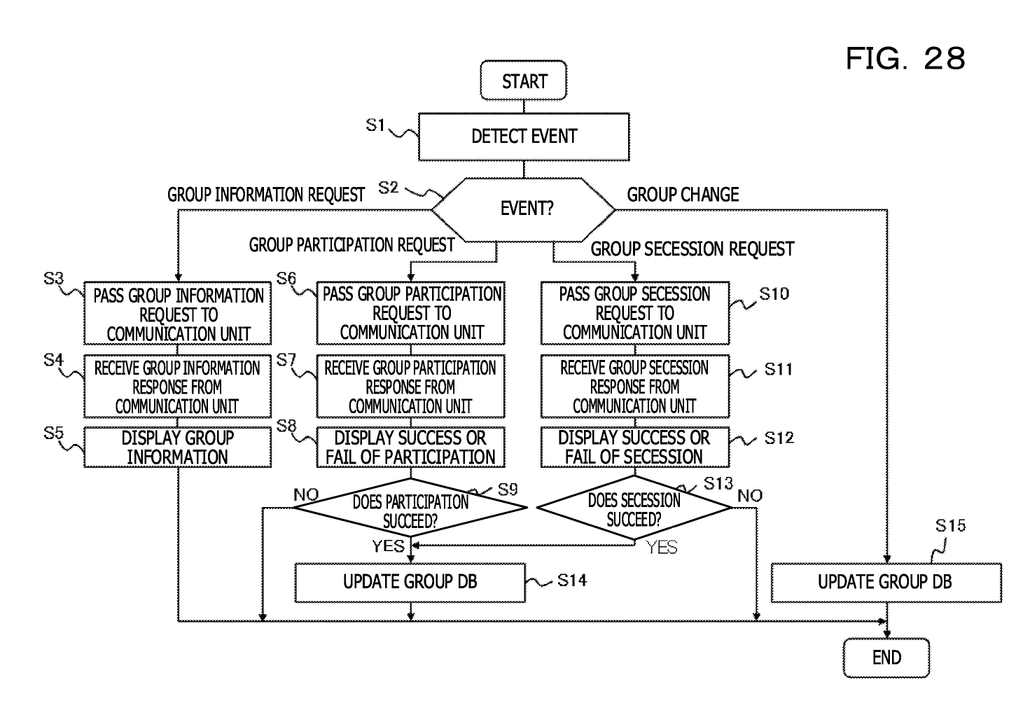

FIG. 28 is a flowchart illustrating the processing of the group processing unit 51. As illustrated in FIG. 24, the group processing unit 51 is provided in a terminal (controller terminal or device terminal).

The processing (S1 to S14) of the group processing unit 51 of the second embodiment is substantially the same as that in the first embodiment. That is, the group processing unit 51 executes processing relating to a request for participating in a designated group, a request for seceding from a designated group, and the like. Meanwhile, in the second embodiment, in S14, the group DB (53 or 63) is updated.

In the second embodiment, when the group processing unit 51 receives the group change notice from the group management apparatus 2, the group processing unit executes the processing of S15. In S15, the group processing unit 51 updates the group DB 53 in response to the received group change notice. For example, in the example illustrated in FIG. 26, when the terminal 02 participates in the group “a”, the group change notice is transmitted from the group management apparatus 2 to the terminal 01. In this case, in the terminal 01, the group processing unit 51 registers the terminal 02 with a record corresponding to the group “a”. Thereafter, the group processing unit 51 may transmit a response message to the group management apparatus 2.

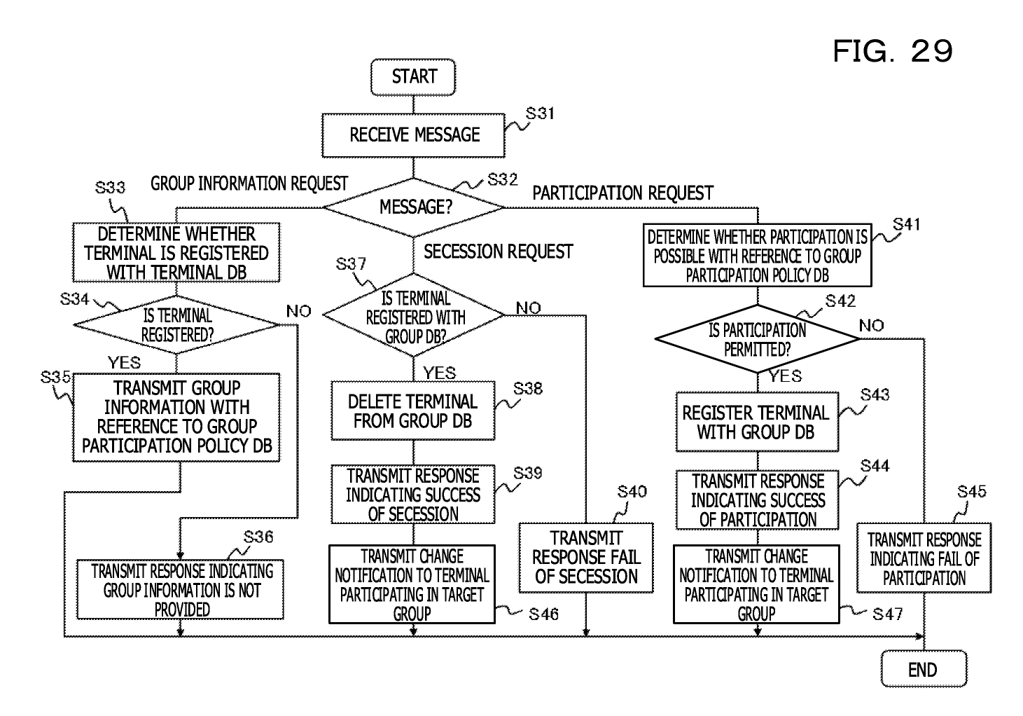

FIG. 29 is a flowchart illustrating the processing of the group management unit 41 of the second embodiment. As illustrated in FIG. 24, the group management unit 41 is provided in the group management apparatus 2.

The processing (S31 to S45) of the group processing unit 41 of the second embodiment is substantially the same as that in the first embodiment. That is, the group processing unit 41 executes processing relating to participation in a group designated in a group participation request and secession from a group designated in a group secession request, and the like.

However, when secession processing is executed in S38 and S39, the processing of the group management unit 41 proceeds to S46. In S46, the group management unit 41 transmits a group change notice to a terminal within a group in which terminal secession is executed. For example, in the example illustrated in FIG. 27, when the terminal 01 secedes from the group “a”, the group management unit 41 transmits a group change notice to a terminal participating in the group “a”. In this case, the group change notice indicating that the terminal 01 secedes from the group “a” is transmitted to the terminal 02.

In addition, when participation processing is executed in S43 and S44, the processing of the group management unit 41 proceeds to S47. In S47, the group management unit 41 transmits a group change notice to a terminal within a group in which terminal participation is executed. For example, in the example illustrated in FIG. 27, when the terminal 02 participates in the group “a”, the group management unit 41 transmits a group change notice to a terminal that previously participates in the group “a”. In this case, the group change notice indicating that the terminal 02 participates in the group “a” is transmitted to the terminal 01.

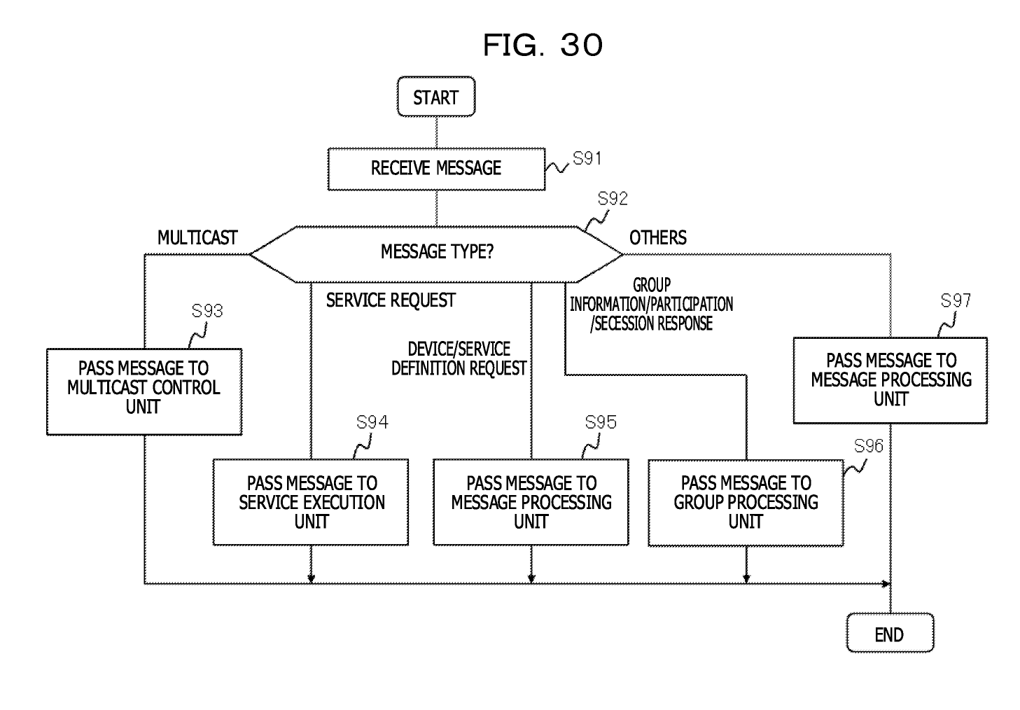

FIG. 30 is a flowchart illustrating the processing of a communication unit provided in a terminal in the second embodiment. The terminal is equivalent to the communication unit 21 provided in the controller terminal or the communication unit 31 provided in the device terminal. Meanwhile, FIG. 30 illustrates processing when a terminal receives a message through a wireless link.

In S91 and S92, the communication unit detects a type of a received message. The processing of the communication unit is determined in accordance with the type of the received message.

When the terminal receives a multicast message, in S93, the communication unit passes the message to the multicast control unit 61 (the multicast control unit 52 in the controller terminal 01). When the terminal receives a service request message, in S94, the communication unit passes the message to the service execution unit 33. When the terminal receives a definition request message (including a device definition request message and a service definition request message), in S95, the communication unit passes the message to the message processing unit 32. When the terminal receives a response message to a group information request, a group participation request, or a group secession request, in S96, the communication unit passes the message to the group processing unit 51. When the terminal receives another message, in S97, the communication unit passes the message to the message processing unit 32 (the message processing unit 23 in the controller terminal 01). Meanwhile, the message processing units 23 and 32 process the message based on UPnP standard, for example.

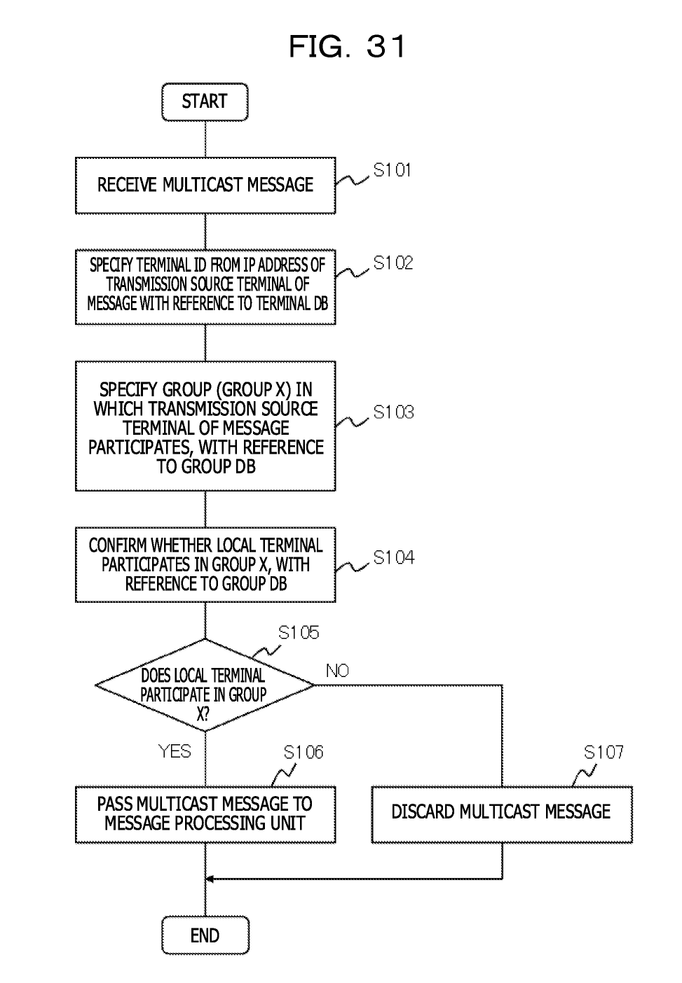

FIG. 31 is a flowchart illustrating the processing of the multicast control unit 61. For example, as illustrated in FIG. 24, the multicast control unit 61 operates in a device terminal.

In S101, the multicast control unit 61 receives a multicast message transmitted from another terminal. Meanwhile, a terminal retrieval request (M-SEARCH) message transmitted from a controller terminal is a multicast message.

In S102, the multicast control unit 61 specifies a terminal ID of a transmission source terminal of the message with reference to the terminal DB 64 using a transmission source IP address of the received message.

In S103, the multicast control unit 61 specifies a group in which the transmission source terminal of the message participates, with reference to the group DB 63 using the specified terminal ID. In the following description, the group specified in this manner will be referred to as a “group X”. That is, the group X indicates a group in which a terminal, which is a transmission source of the received multicast message, participates.

In S104 and S105, the multicast control unit 61 determines whether a local terminal participates in the group X with reference to the group DB 63. That is, it is determined whether the transmission source terminal of the multicast message and the local terminal belong to the same group.

When the local terminal participates in the group X, in S106, the multicast control unit 61 passes the received multicast message to the message processing unit 32. On the other hand, when the local terminal does not participate in the group X, in S107, the multicast control unit 61 discards the received multicast message.

Although not particularly illustrated in the drawing, the message processing unit 32 may process a message based on UPnP standard. For example, when a terminal retrieval request (M-SEARCH) message is received, the message processing unit 32 generates a response message (M-SEARCH response message). At this time, the message processing unit 32 may generate a response message for notifying the presence of a terminal and a response message for notifying the presence of a service capable of being provided. In addition, when a definition request is received, the message processing unit 32 may generate a response message including corresponding definition information (device definition information or service definition information).

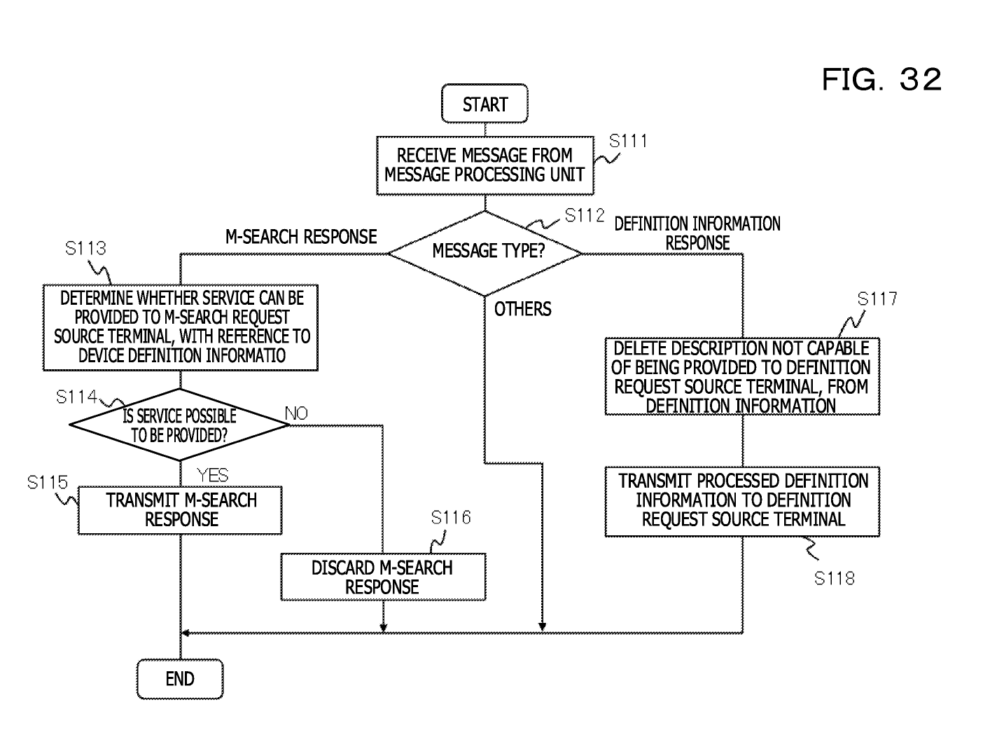

FIG. 32 is a flowchart illustrating the processing of the service access control unit 62. For example, as illustrated in FIG. 24, the service access control unit 62 operates in a device terminal.

In S111 and S112, the service access control unit 62 detects a type of a message which is received from the message processing unit 32. The processing of the service access control unit 62 is determined in accordance with the type of the received message.

When the response message (that is, M-SEARCH response message) for the terminal retrieval request is received, the processing of the service access control unit 62 proceeds to S113. In S113 and S114, the service access control unit 62 determines whether the M-SEARCH response message is transmitted to the transmission source terminal of the M-SEARCH message. At this time, the service access control unit 62 specifies a corresponding terminal ID from a destination IP address (that is, the transmission source IP address of the M-SEARCH message) of the M-SEARCH response message, with reference to the terminal DB 64. In addition, the service access control unit 62 specifies a group in which a terminal identified by the terminal ID participates, with reference to the group DB 63. Then, the service access control unit 62 determines whether a response message may be transmitted to the specified group, based on an access policy described in device definition information. That is, it is determined whether a response message may be transmitted to the transmission source terminal of the M-SEARCH message. The determination is executed for each service capable of being provided (that is, for each service listed in the device definition information).

When information is permitted to be provided to the transmission source terminal of the M-SEARCH message, in S115, the service access control unit 62 transmits the M-SEARCH response message to the transmission source terminal. On the other hand, when information is not permitted to be provided to the transmission source terminal of the M-SEARCH message, in S116, the service access control unit 62 discards the M-SEARCH response message without transmitting the message.

When a response message to a definition request is received, the processing of the service access control unit 62 proceeds to S117. In S117, the service access control unit 62 determines whether to be capable of providing definition information (device definition information or service definition information) which is included in the response message to a transmission source terminal of the definition request. At this time, the service access control unit 62 specifies a corresponding terminal ID from a destination IP address (that is, a transmission source IP address of the definition request) of the response message including the definition information, with reference to the terminal DB 64. In addition, the service access control unit 62 specifies a group in which a terminal identified by the terminal ID participates, with reference to the group DB 63. Further, the service access control unit 62 determines whether the definition information may be provided to the specified group, based on the access policy described in device definition information. That is, it is determined whether the definition information may be provided to the transmission source terminal of the definition request. The determination is executed for each service capable of being provided (that is, for each service which is listed in the device definition information). When a description not permitted to be provided is included in the definition information, the service access control unit 62 deletes the description from the definition information.

In S118, the service access control unit 62 transmits a response message including the requested definition information to the transmission source terminal of the definition request. Meanwhile, a description not permitted to a terminal which is a transmission source of the definition request is deleted from the definition information in the response message.

Next, examples of a terminal retrieval request and a response thereto will be described. In the following description, it is assumed that the controller terminal 01 executes a terminal retrieval request in the network system illustrated in FIG. 23.

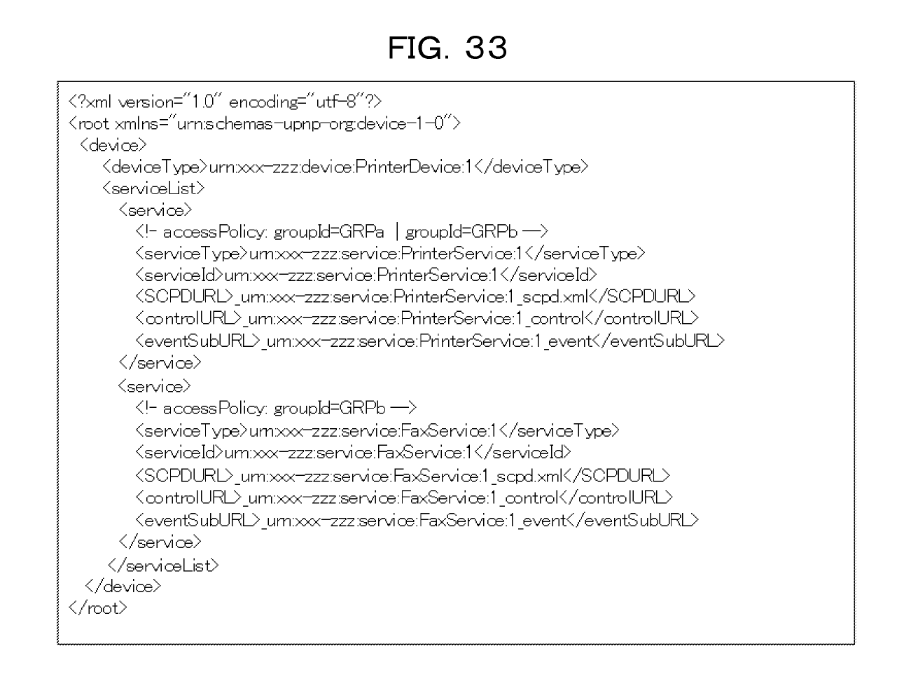

It is assumed that the device terminal 02 has device definition information illustrated in FIG. 33 in the device definition storage unit 34. In this example, the device terminal 02 may provide two services (a printer service and a facsimile service). In the device definition information, an access policy is described for each service capable of being provided. Therefore, the provision destination may be limited for each service. In this example, the printer service is permitted to the group “a” and the group “b”, and the facsimile service is permitted to only the group “b”. Meanwhile, in the example illustrated in FIG. 33, the access policy is described with an XML comment, but may be described using another method. For example, a new tag may be defined in order to describe the access policy.

The controller terminal 01 transmits a terminal retrieval request (M-SEARCH) message to the group management apparatus 2. As illustrated in FIG. 18A, it is assumed that the M-SEARCH message retrieves all terminals and services within a subnet. In addition, the M-SEARCH message is a multicast message. Accordingly, in contrast to the first embodiment, the M-SEARCH message is forwarded to all the terminals within the subnet.

Each terminal has the groups DB 53 and 63. Accordingly, each terminal having received the M-SEARCH message recognizes that a transmission source of the M-SEARCH message is the controller terminal 01 and that the controller terminal 01 participates in the group “a”.

The terminal 03 participates in the group “b”, but does not participate in the group “a”. That is, the controller terminal 01 and the terminal 03 do not belong to the same group. Therefore, the terminal 03 does not return a response message to the M-SEARCH message transmitted from the controller terminal 01. As a result, the controller terminal 01 may not detect the presence of the terminal 03.

The terminal 02 participates in the group “a” and the group “b”. That is, both the controller terminal 01 and the terminal 02 belong to the group “a”. Therefore, the terminal 02 returns a response message to the M-SEARCH message transmitted from the controller terminal 01. As a result, the controller terminal 01 detects the presence of the terminal 02.

At this time, the terminal 02 generates a response message for each of services that are listed within device definition information. However, the terminal 02 determines whether to transmit these response messages to the controller terminal 01 with reference to an access policy described within the device definition information. In the example illustrated in FIG. 33, a printer service is permitted to the group “a” and the group “b”, but a facsimile service is permitted to only the group “b”. In this case, the terminal 02 transmits a response message for notifying the presence of the printer service to the controller terminal 01. On the other hand, the terminal 02 discards a response message for notifying the presence of the facsimile service.

In this manner, only information of a service permitted to a group in which the controller terminal 01 participates is provided to the controller terminal 01. That is, the terminal 02 may limit a service to be provided to the controller terminal 01, based on an attribute of the controller terminal 01.

Next, in the second embodiment, a description will be given of an example of a procedure of causing a controller terminal to request definition information from a device terminal. In the following description, it is assumed that the controller terminal 01 receives the M-SEARCH response message illustrated in FIG. 19 from the device terminal 02 in a terminal retrieval procedure.

The controller terminal 01 generates a device definition request message (HTTP GET message) and transmits the message to the device terminal 02. At this time, a URL set in a Location field of the M-SEARCH response message illustrated in FIG. 19 is designated.

The device definition request message is forwarded by the group management apparatus 2, and is received by the device terminal 02. Then, the device terminal 02 creates a response message including the device definition information illustrated in FIG. 33.

However, the device terminal 02 refers to an access policy described within the device definition information before transmitting the response message. The device terminal 02 determines whether the definition information may be provided to the controller terminal 01, for each service. In the example illustrated in FIG. 33, the printer service is permitted to the group “a” and the group “b”, but the facsimile service is permitted to only the group “b”. In this case, it is determined that the definition information on the facsimile service is not provided to the controller terminal 01. Then, the device terminal 02 deletes a description (from <service> to </service>) which relates to the facsimile service in the device definition information. Then, the device terminal 02 transmits a response message including updated device definition information to the controller terminal 01.

Thereafter, the controller terminal 01 requests service definition information from the device terminal 02. Then, the device terminal 02 transmits service definition information from which a description not permitted to the group “a” is deleted, to the controller terminal 01. A procedure of providing the service definition information from the device terminal to the controller terminal is similar to the procedure of providing the device definition information from the device terminal to the controller terminal, and thus the detailed description thereof will be omitted.

### OTHER EMBODIMENTS

In the first embodiment, conversion from a multicast terminal retrieval request message to a unicast terminal retrieval request message is performed in a relay apparatus 1. This conversion processing may be performed in any terminal. In this case, the terminal receives information indicating a configuration of each group from a group management apparatus, and determines a group in which a transmission source terminal of the multicast terminal retrieval request message participates. The terminal transmits the unicast terminal retrieval request message to each terminal within the determined group. According to this configuration, it is possible to perform communication that does not pass through the relay apparatus.

In the network illustrated in FIG. 1, the relay apparatus 1 may forward the received multicast terminal retrieval request message as it is to all terminals within a subnet. However, in this case, the relay apparatus 1 discards a response message which is not permitted to be provided to the transmission source terminal of the multicast terminal retrieval request message, among response messages transmitted from device terminals within the subnet. At this time, the relay apparatus 1 refers to a group DB 17 and an access policy DB 16.

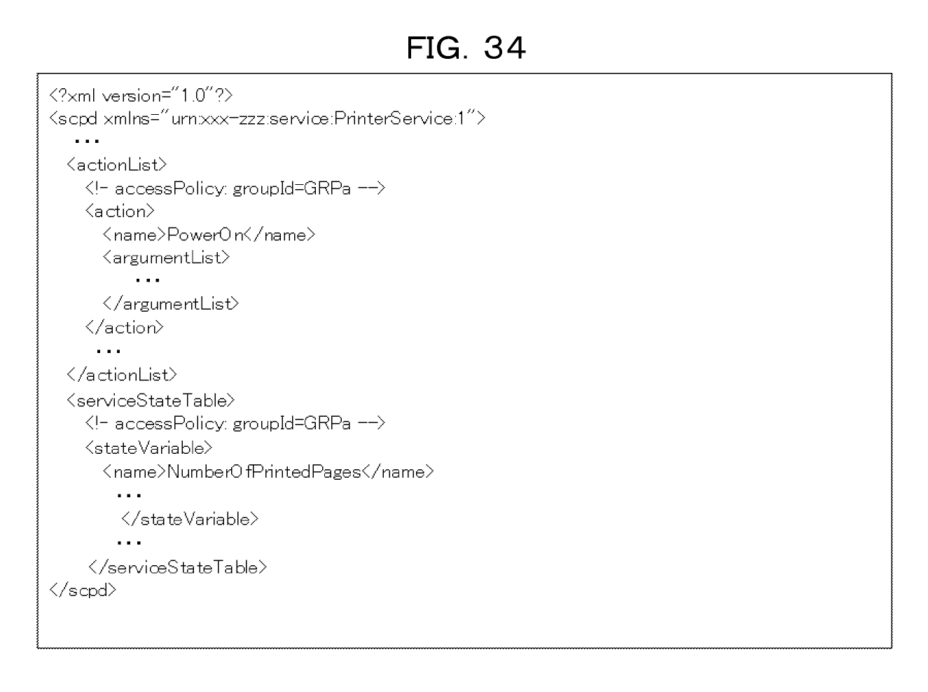

In the above-described embodiment, a type of a service to be provided to a controller terminal is limited in accordance with an attribute of the controller terminal. In addition, an access control method of the embodiment may limit the execution of individual actions described within service definition information, in accordance with an attribute of the terminal. For example, it is assumed that a plurality of actions (a power-on action, a power-off action, a color printing action, a black and white printing action, etc.) are described in service definition information of a device terminal that provides a printer service. In this case, a group to which the execution is permitted is designated for each action. In the example illustrated in FIG. 34, a power-on action is permitted to a group “a”. According to this configuration, it is possible to cause only a terminal participating in a specific group to execute a specific action.

Similarly, the access control method of the embodiment may limit the provision of individual state variables that are described within service definition information, in accordance with an attribute of a terminal. For example, it is assumed that a plurality of state variables (the number of printed pages, the number of printer papers remaining, the amount of toner remaining, etc.) are described in the service definition information. In this case, a group to which the provision is permitted is designated for each state variable. In the example illustrated in FIG. 34, the reference to the number of printed pages is permitted to the group “a”. According to this configuration, a reference to a specific state variable is permitted to only a terminal participating in a specific group.

Meanwhile, in UPnP, a procedure for notifying an event with each updating of a state variable is defined. At this time, a state variable name set in an event notification message is compared with an access policy for each state variable included in service definition information, and the event notification message may be transmitted to only a terminal participating in a group to which access to the state variable is permitted. In this case, it is possible to limit a terminal capable of having access to the state variable for each group.

In the above-described embodiment, access control is performed for each group, but a configuration may be adopted in which a specific controller terminal may receive a specific service at all times, regardless of a group in which a controller terminal participates. A method for realizing this configuration will be described based on the first embodiment.

It is possible to register a terminal ID for identifying a terminal with an access policy column of an access policy DB 19. When the relay apparatus 1 receives a multicast terminal retrieval request message, the relay apparatus retrieves a service type in which a terminal ID for identifying a transmission source of the message is registered, with reference to the access policy column of the access policy DB 19. When such a service type is not retrieved, access control based on a participation group is executed. On the other hand, when such a service type is retrieved, the relay apparatus 1 transmits a terminal retrieval request message to a device terminal that provides the service. Thus, the controller terminal may receive a terminal retrieval response message from the device terminal that provides the service.

Hardware Configuration

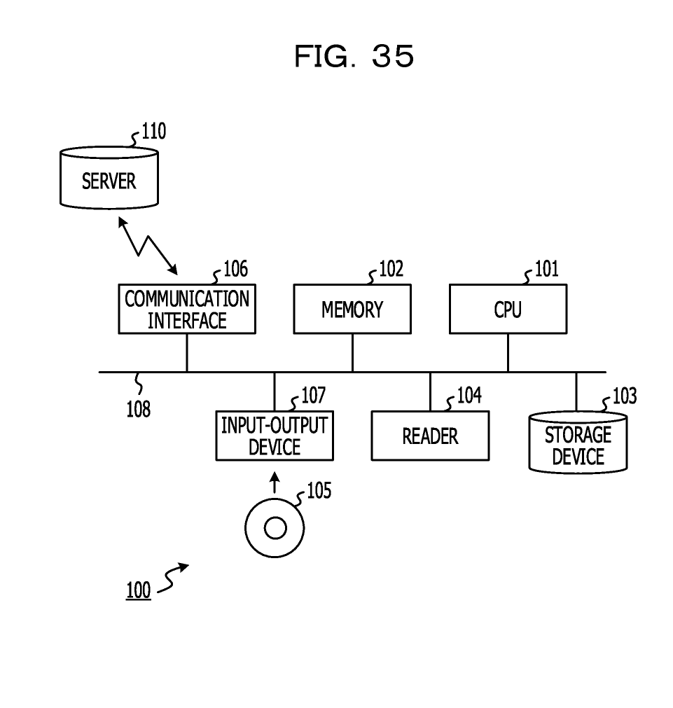

FIG. 35 illustrates a hardware configuration of an apparatus which is used in the network system of the embodiment. The apparatus used in the network system includes terminals (controller terminal and device terminal), the relay apparatus 1 of the first embodiment, and the group management apparatus 2 of the second embodiment. In addition, the apparatuses are realized by a computer system 100 illustrated in FIG. 35, for example.

The computer system 100 includes a CPU 101, a memory 102, a storage device 103, a reader 104, a communication interface 106, and an input-output device 107. The CPU 101, the memory 102, the storage device 103, the reader 104, the communication interface 106, and the input-output device 107 are connected to each other through a bus 108, for example.

The CPU 101 executes an access control program using the memory 102, and thus may provide the functions illustrated in the above-described flowchart. The memory 102 is a semiconductor memory, for example, and is configured to include a RAM region and a ROM region. The storage device 103 is, for example, a hard disk device, and may store the access control program. Meanwhile, the storage device 103 may be a semiconductor memory such as a flash memory. In addition, the storage device 103 may be an external storage device.

The reader 104 has access to a detachable recording medium 105 in accordance with an instruction of the CPU 101. The detachable recording medium 105 is realized by, for example, a semiconductor device (USB memory or the like), a medium to and from which information is input and output by magnetic action (magnetic disk or the like), a medium to and from which information is input and output by optical action (CD-ROM, DVD, or the like), or the like. The communication interface 106 transmits and receives data through a network in accordance with an instruction of the CPU 101. The input-output device 107 includes, for example, a device that receives an instruction from a user.

The access control program of the embodiment is provided to the computer system 100 in the following form, for example.

(1) The program is installed in the storage device 103 in advance.

(2) The program is provided by the detachable recording medium 105.

(3) The program is provided from the program server 110.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay server which relays communication between terminals, the server comprising:
a processor; and
a memory which stores a plurality of instructions, which when executed by the processor, cause the processor to execute,
storing policy information that designates a service capable of being provided for each group which is participated by at least one of the terminals,
processing, based on the policy information, response information included in a response from a second terminal which corresponds to a request from a first terminal and
transmitting the response information processed by the processor to the first terminal by communication,
wherein the processing of the response information includes processing the response information such that a service capable of being provided by the second terminal is limited to a service capable of being provided to a group in which the first terminal participates.

2. The server according to claim 1,
wherein the response information includes a description relating to the service capable of being provided by the second terminal, and
wherein the processing of the response information includes deleting, from the response information, a description relating to a service other than the service capable of being provided to the group in which the first terminal participates.

3. The server according to claim 1,
wherein the processor further executes:
storing group information indicating a participating terminal for each group; and
when a terminal retrieval request to retrieve a terminal which is present within a network is received from the first terminal, requesting the terminal retrieval request from a terminal belonging to the same group as the first terminal, based on the group information.

4. The server according to claim 3,
wherein the terminal retrieval request is stored in a multicast message which is transmitted to a plurality of terminals within the network, and is transmitted from the first terminal, and
wherein the requesting of the terminal retrieval request includes converting the multicast message received from the first terminal to a unicast message and transmitting the unicast message to each of terminals participating in the same group as the first terminal.

5. The server according to claim 3,
wherein when information on a service not permitted to a group in which the first terminal participates is included in a response message returned from a terminal having received the terminal retrieval request, the requesting of the terminal retrieval request includes discarding the response message without forwarding the response message to the first terminal.

6. An access control method used in a relay server which relays communication between terminals, the method comprising:
forwarding a request transmitted from a first terminal to a second terminal;
receiving, from the second terminal, a response corresponding to the request;
processing, by a computer processor, response information included in the response such that a service capable of being provided by the second terminal is limited to a service capable of being provided to a group in which the first terminal participates, based on policy information that designates a service capable of being provided for each group which is participated by at least one of the terminals; and
transmitting the processed response information to the first terminal.

7. A computer-readable storage medium storing an access control program that causes a computer to execute a process comprising:
forwarding a request transmitted from a first terminal to a second terminal;
receiving, from the second terminal, a response corresponding to the request;
processing response information included in the response such that a service capable of being provided by the second terminal is limited to a service capable of being provided to a group in which the first terminal participates, based on policy information that designates a service capable of being provided for each group which is participated by at least one of the terminals; and
transmitting the processed response information to the first terminal.

8. A service providing device which responds to a request from a service request terminal, the device comprising:
a processor; and
a memory which stores a plurality of instructions, which when executed by the processor, cause the processor to execute,
storing definition information in which information on a service capable of being provided by the service providing device is described,
when a definition request that requests the definition information is received, processing the definition information such that the service capable of being provided by the service providing device is limited to a service capable of being provided to a group in which the service request terminal participates, and
transmitting the processed definition information to the service request terminal by communication.

9. The device according to claim 8,
wherein the processing of the definition information includes deleting, from the definition information, a description relating to a service other than the service capable of being provided to the group in which the service request terminal participates.

10. The device according to claim 8,
wherein the processor further executes:
storing group information indicating a participating terminal for each group which is participated by at least one of the terminals;
when a terminal retrieval request to retrieve a terminal which is present within a network is received from the service request terminal, determining whether the service request terminal and the service providing device participate in the same group, based on the group information; and
when the service request terminal and the service providing device participate in the same group, generating a response message corresponding to the terminal retrieval request and transmitting the response message to the service request terminal, and when the service request terminal and the service providing device do not participate in the same group, discarding the terminal retrieval request.

11. The device according to claim 10,
wherein when information on a service which is not permitted to a group in which the service request terminal participates is included in the response message, the discarding of the terminal retrieval request includes discarding the response message without transmitting the response message to the service request terminal.

12. An access control method used in a service providing device which responds to a request from a service request terminal, the method comprising:
reading out definition information in which information on a service capable of being provided by the service providing device is described, from a definition information storage unit, in accordance with the request from the service request terminal;
processing, by a computer processor, the definition information such that the service capable of being provided by the service providing device is limited to a service capable of being provided to a group in which the service request terminal participates; and
transmitting the processed definition information to the service request terminal.

13. A computer-readable storage medium storing an access control program that causes a computer to execute a process comprising:
reading out definition information in which information on a service capable of being provided is described, from a definition information storage unit, in accordance with a request from a service request terminal;
processing the definition information such that the service capable of being provided is limited to a service capable of being provided to a group in which the service request terminal participates; and
transmitting the processed definition information to the service request terminal.
